SEQUENCE LISTING (9 sequences)

SEQ ID NO: 1 - DNA, 1459 bp, Bacillus subtilis
  source 1..1459: mol_type = genomic DNA
atgttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaacggctcaccaaggcaacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaaggtgggacagatgattggggtgaagtcgtaacaaggtagccgtatcggaaggtgcggctggatcacctccttt

SEQ ID NO: 2 - DNA, 1546 bp, Bacillus amyloliquefaciens
  source 1..1546: mol_type = genomic DNA
cggagagtttgatcctggctcaggacgaacgctggcggcgtgcctaatacatgcaagtcgagcggacagatgggagcttgctccctgatgttagcggcggacgggtgagtaacacgtgggtaacctgcctgtaagactgggataactccgggaaaccggggctaataccggatgcttgtttgaaccgcatggttcaaacataaaaggtggcttcggctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgccgttcaaatagggcggcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatgggcagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaacctttttggagccagccgccgaaggtgggacagatgattggggtgaagtcgtaacaaggtagccgtatcggaaggtgcggctggatcacctccttt

SEQ ID NO: 3 - DNA, 1325 bp, Bacillus licheniformis
  source 1..1325: mol_type = genomic DNA
cacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaaactctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagcgcgcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggcgcgaaagcgtggggagcgaacaggattagataccctggtagtccacgccgtaaacgatgagtgctaagtgttagagggtttccgccctttagtgctgcagcaaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggcttccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatgggcagaacaaagggcagcgaagccgcgaggctaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttggagccagccgccgaaggtgggacagatgattggggtgaagtcgtaacaaggtagccgtatcggaaggtgcggctggatcacctccttt

SEQ ID NO: 4 - DNA, 1517 bp, Bacillus pumilus
  source 1..1517: mol_type = genomic DNA
acgctggcggcgtgcctaatacatgcaagtcgagcggacagaagggagcttgctcccggatgttagcggcggacgggtgagtaacacgtgggtaacctgcctgtaagactgggataactccgggaaaccggagctaataccggatagttccttgaaccgcatggttcaaggatgaaagacggtttcggctgtcacttacagatggacccgcggcgcattagctagttggtggggtaatggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtgcgagagtaactgctcgcaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactgggaaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaaccctagagatagggctttcccttcggggacagagtgacaggtggtgcatggttgtcgtcagctcgtgtcgtgagatgttgggttaagtcccgcaacgagcgcaacccttgatcttagttgccagcatttagttgggcactctaaggtgactgccggtgacaaaccggaggaaggtggggatgacgtcaaatcatcatgccccttatgacctgggctacacacgtgctacaatggacagaacaaagggctgcgagaccgcaaggtttagccaatcccataaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgcaacacccgaagtcggtgaggtaacctttatggagccagccgccgaaggtggggcagatgattggggtgaagtcgtaacaaggtagccgtatcggaaggtgcggctggatcacctccttt

SEQ ID NO: 5 - DNA, 1572 bp, Pediococcus pentosaceus
  source 1..1572: mol_type = genomic DNA
atgagagtttgatcttggctcaggatgaacgctggcggcgtgcctaatacatgcaagtcgaacgaacttccgttaattgattatgacgtacttgtactgattgagattttaacacgaagtgagtggcgaacgggtgagtaacacgtgggtaacctgcccagaagtaggggataacacctggaaacagatgctaataccgtataacagagaaaaccgcatggttttcttttaaaagatggctctgctatcacttctggatggacccgcggcgtattagctagttggtgaggtaaaggctcaccaaggcagtgatacgtagccgacctgagagggtaatcggccacattgggactgagacacggcccagactcctacgggaggcagcagtagggaatcttccacaatggacgcaagtctgatggagcaacgccgcgtgagtgaagaagggtttcggctcgtaaagctctgttgttaaagaagaacgtgggtaagagtaactgtttacccagtgacggtatttaaccagaaagccacggctaactacgtgccagcagccgcggtaatacgtaggtggcaagcgttatccggatttattgggcgtaaagcgagcgcaggcggtcttttaagtctaatgtgaaagccttcggctcaaccgaagaagtgcattggaaactgggagacttgagtgcagaagaggacagtggaactccatgtgtagcggtgaaatgcgtagatatatggaagaacaccagtggcgaaggcggctgtctggtctgcaactgacgctgaggctcgaaagcatgggtagcgaacaggattagataccctggtagtccatgccgtaaacgatgattactaagtgttggagggtttccgcccttcagtgctgcagctaacgcattaagtaatccgcctggggagtacgaccgcaaggttgaaactcaaaagaattgacgggggcccgcacaagcggtggagcatgtggtttaattcgaagctacgcgaagaaccttaccaggtcttgacatcttctgacagtctaagagattagaggttcccttcggggacagaatgacaggtggtgcatggttgtcgtcagctcgtgtcgtgagatgttgggttaagtcccgcaacgagcgcaacccttattactagttgccagcattaagttgggcactctagtgagactgccggtgacaaaccggaggaaggtggggacgacgtcaaatcatcatgccccttatgacctgggctacacacgtgctacaatggatggtacaacgagtcgcgagaccgcgaggttaagctaatctcttaaaaccattctcagttcggactgtaggctgcaactcgcctacacgaagtcggaatcgctagtaatcgcggatcagcatgccgcggtgaatacgttcccgggccttgtacacaccgcccgtcacaccatgagagtttgtaacacccaaagccggtggggtaaccttttaggagctagccgtctaaggtgggacagatgattagggtgaagtcgtaacaaggtagccgtaggagaacctgcggctggatcacctcctt

SEQ ID NO: 6 - DNA, 1328 bp, unidentified
  source 1..1328: mol_type = genomic DNA; note = Lactiplantibacillus plantarum
ctatcacttttggatggtcccgcggcgtattagctagatggtggggtaacggctcaccatggcaatgatacgtagccgacctgagagggtaatcggccacattgggactgagacacggcccaaactcctacgggaggcagcagtagggaatcttccacaatggacgaaagtctgatggagcaacgccgcgtgagtgaagaagggtttcggctcgtaaaactctgttgttaaagaagaacatatctgagagtaactgttcaggtattgacggtatttaaccagaaagccacggctaactacgtgccagcagccgcggtaatacgtaggtggcaagcgttgtccggatttattgggcgtaaagcgagcgcaggcggttttttaagtctgatgtgaaagccttcggctcaaccgaagaagtgcatcggaaactgggaaacttgagtgcagaagaggacagtggaactccatgtgtagcggtgaaatgcgtagatatatggaagaacaccagtggcgaaggcggctgtctggtctgtaactgacgctgaggctcgaaagtatgggtagcaaacaggattagataccctggtagtccataccgtaaacgatgaatgctaagtgttggagggtttccgcccttcagtgctgcagctaacgcattaagcattccgcctggggagtacggccgcaaggctgaaactcaaaggaattgacgggggcccgcacaagcggtggagcatgtggtttaattcgaagctacgcgaagaaccttaccaggtcttgacatactatgcaaatctaagagattagacgttcccttcggggacatggatacaggtggtgcatggttgtcgtcagctcgtgtcgtgagatgttgggttaagtcccgcaacgagcgcaacccttattatcagttgccagcattaagttgggcactctggtgagactgccggtgacaaaccggaggaaggtggggatgacgtcaaatcatcatgccccttatgacctgggctacacacgtgctacaatggatggtacaacgagttgcgaactcgcgagagtaagctaatctcttaaagccattctcagttcggattgtaggctgcaactcgcctacatgaagtcggaatcgctagtaatcgcggatcagcatgccgcggtgaatacgttcccgggccttgtacacaccgcccgtcacaccatgagagtttgtaacacccaaagtcggtggggtaaccttttaggaaccagccgcctaaggtgggacagatgattagggtgaagtcgtaacaaggtagccgtaggagaacctgcggctggatcacctcctt

SEQ ID NO: 7 - DNA, 1525 bp, Lactobacillus delbrueckii
  source 1..1525: mol_type = genomic DNA
agagtttgatcctggctcaggacgaacgctggcggcgtgcctaatacatgcaagtcgagcgagctgaattcaaagatcccttcggggtgatttgttggacgctagcggcggatgggtgagtaacacgtgggcaatctgccctaaagactgggataccacttggaaacaggtgctaataccggataacaacatgaatcgcatgattcaagtttgaaaggcggcgcaagctgtcactttaggatgagcccgcggcgcattagctagttggtggggtaaaggcctaccaaggcaatgatgcgtagccgagttgagagactgatcggccacattgggactgagacacggcccaaactcctacgggaggcagcagtagggaatcttccacaatggacgcaagtctgatggagcaacgccgcgtgagtgaagaaggtcttcggatcgtaaagctctgttgttggtgaagaaggatagaggcagtaactggtctttatttgacggtaatcaaccagaaagtcacggctaactacgtgccagcagccgcggtaatacgtaggtggcaagcgttgtccggatttattgggcgtaaagcgagcgcaggcggaatgataagtctgatgtgaaagcccacggctcaaccgtggaactgcatcggaaactgtcattcttgagtgcagaagaggagagtggaactccatgtgtagcggtggaatgcgtagatatatggaagaacaccagtggcgaaggcggctctctggtctgcaactgacgctgaggctcgaaagcatgggtagcgaacaggattagataccctggtagtccatgccgtaaacgatgagcgctaggtgttggggactttccngtcctcagtgccgcagcaaacgcattaagcgctccgcctggggagtacgaccgcaaggttgaaactcaaaggaattgacgggggcccgcacaagcggtggagcatgtggtttaattcgaagcaacgcgaagaaccttaccaggtcttgacatcctgcgctacacctagagataggtggttcccttcggggacgcagagacaggtggtgcatggctgtcgtcagctcgtgtcgtgagatgttgggttaagtcccgcaacgagcgcaacccttgtctttagttgccatcattaagttgggcactctaaagagactgccggtgacaaaccggaggaaggtggggatgacgtcaagtcatcatgccccttatgacctgggctacacacgtgctacaatgggcagtacaacgagaagcnaacccgcgagggtaagcggatctcttaaagctgttctcagttcggactgcaggctgcaactcgcctgcacgaagctggaatcgctagtaatcgcggatcagcacgccgcggtgaatacgttcccgggccttgtacacaccgcccgtcacaccatggaagtctgcaatgcccaaagtcggtgagataacctttataggagtcagccgcctaaggcagggcagatgactggggtgaagtcgtaacaaggtaacc

SEQ ID NO: 8 - DNA, 1572 bp, unidentified
  source 1..1572: mol_type = genomic DNA; note = Limosilactobacillus fermentum
tatgagagtttgatcctggctcaggatgaacgccggcggtgtgcctaatacatgcaagtcgaacgcgttggcccaattgattgatggtgcttgcacctgattgattttggtcgccaacgagtggcggacgggtgagtaacacgtaggtaacctgcccagaagcgggggacaacatttggaaacagatgctaataccgcataacaacgttgttcgcatgaacaacgcttaaaagatggcttctcgctatcacttctggatggacctgcggtgcattagcttgttggtggggtaatggcctaccaaggcgatgatgcatagccgagttgagagactgatcggccacaatgggactgagacacggcccatactcctacgggaggcagcagtagggaatcttccacaatgggcgcaagcctgatggagcaacaccgcgtgagtgaagaagggtttcggctcgtaaagctctgttgttaaagaagaacacgtatgagagtaactgttcatacgttgacggtatttaaccagaaagtcacggctaactacgtgccagcagccgcggtaatacgtaggtggcaagcgttatccggatttattgggcgtaaagagagtgcaggcggttttctaagtctgatgtgaaagccttcggcttaaccggagaagtgcatcggaaactggataacttgagtgcagaagagggtagtggaactccatgtgtagcggtggaatgcgtagatatatggaagaacaccagtggcgaaggcggctacctggtctgcaactgacgctgagactcgaaagcatgggtagcgaacaggattagataccctggtagtccatgccgtaaacgatgagtgctaggtgttggagggtttccgcccttcagtgccggagctaacgcattaagcactccgcctggggagtacgaccgcaaggttgaaactcaaaggaattgacgggggcccgcacaagcggtggagcatgtggtttaattcgaagctacgcgaagaaccttaccaggtcttgacatcttgcgccaaccctagagatagggcgtttccttcgggaacgcaatgacaggtggtgcatggtcgtcgtcagctcgtgtcgtgagatgttgggttaagtcccgcaacgagcgcaacccttgttactagttgccagcattaagttgggcactctagtgagactgccggtgacaaaccggaggaaggtggggacgacgtcagatcatcatgccccttatgacctgggctacacacgtgctacaatggacggtacaacgagtcgcgaactcgcgagggcaagcaaatctcttaaaaccgttctcagttcggactgcaggctgcaactcgcctgcacgaagtcggaatcgctagtaatcgcggatcagcatgccgcggtgaatacgttcccgggccttgtacacaccgcccgtcacaccatgagagtttgtaacacccaaagtcggtggggtaaccttttaggagccagccgcctaaggtgggacagatgattagggtgaagtcgtaacaaggtagccgtaggagaacctgcggctggatcacctcctt

SEQ ID NO: 9 - DNA, 1457 bp, Bacillus subtilis
  source 1..1457: mol_type = genomic DNA
gttagcggcggacgggtgagtaacacgtgggtaacctgcctgtaagactgggataactccgggaaaccggggctaataccggatggttgtttgaaccgcatggttcaaacataaaaggtggcttcggctaccacttacagatggacccgcggcgcattagctagttggtgaggtaacggctcaccaaggcgacgatgcgtagccgacctgagagggtgatcggccacactgggactgagacacggcccagactcctacgggaggcagcagtagggaatcttccgcaatggacgaaagtctgacggagcaacgccgcgtgagtgatgaaggttttcggatcgtaaagctctgttgttagggaagaacaagtaccgttcgaatagggcggtaccttgacggtacctaaccagaaagccacggctaactacgtgccagcagccgcggtaatacgtaggtggcaagcgttgtccggaattattgggcgtaaagggctcgcaggcggtttcttaagtctgatgtgaaagcccccggctcaaccggggagggtcattggaaactggggaacttgagtgcagaagaggagagtggaattccacgtgtagcggtgaaatgcgtagagatgtggaggaacaccagtggcgaaggcgactctctggtctgtaactgacgctgaggagcgaaagcgtggggagcgaacaggattagataccctggtagtccacgccgtaaacgatgagtgctaagtgttagggggtttccgccccttagtgctgcagctaacgcattaagcactccgcctggggagtacggtcgcaagactgaaactcaaaggaattgacgggggcccgcacaagcggtggagcatgtggtttaattcgaagcaacgcgaagaaccttaccaggtcttgacatcctctgacaatcctagagataggacgtccccttcgggggcagagtgacaggtggtgcatggttgtcgtcagctcgtgtcgtgagatgttgggttaagtcccgcaacgagcgcaacccttgatcttagttgccagcattcagttgggcactctaaggtgactgccggtgacaaaccggaggaaggtggggatgacgtcaaatcatcatgccccttatgacctgggctacacacgtgctacaatggacagaacaaagggcagcgaaaccgcgaggttaagccaatcccacaaatctgttctcagttcggatcgcagtctgcaactcgactgcgtgaagctggaatcgctagtaatcgcggatcagcatgccgcggtgaatacgttcccgggccttgtacacaccgcccgtcacaccacgagagtttgtaacacccgaagtcggtgaggtaaccttttaggagccagccgccgaaggtgggacagatgattggggtgaagtcgtaacaaggtagccgtatcggaaggtgcggctggatcacctccttt

(19) United States
(12) Patent Application Publication
(10) Pub. No.: US 2025/0234900 A1
(43) Pub. Date: Jul. 24, 2025

(54) COMPOSITIONS AND METHODS OF USE THEREOF FOR TREATING AND PREVENTING HALITOSIS

(71) Applicant: Imvela Corp., Brooklyn, NY (US)

(72) Inventors: Raphaël Turcotte, Brooklyn, NY (US); Ravi Sheth, Brooklyn, NY (US)

(73) Assignee: Imvela Corp., Brooklyn, NY (US)

(21) Appl. No.: 18/790,185

(22) Filed: Jul. 31, 2024

Related U.S. Application Data
(60) Provisional application No. 63/622,511, filed on Jan. 18, 2024.

(51) Int. Cl. A23K 10/10; A23K 10/30; A23K 20/147; A23K 20/163; A23K 50/40

(52) U.S. Cl. CPC A23K 10/10; A23K 10/30; A23K 20/147; A23K 20/163; A23K 50/40

(57) ABSTRACT

Some aspects of the disclosure relate to compositions comprising fermentates of bacterial strains capable of reducing volatile sulfur compounds (VSCs) in an environment, nutritional supplements, dental supplements, and food products containing such fermentates, and methods of use thereof.

### RELATED APPLICATION

This application claims the benefit under 35 U.S.C. § 119 (e) of U.S. Provisional Application No. 63/622,511, filed Jan. 18, 2024, the contents of which are incorporated by reference herein in their entirety.

### REFERENCE TO AN ELECTRONIC SEQUENCE LISTING

The contents of the electronic sequence listing (1055870005US01-SEQ-NTJ.xml; Size: 22,511 bytes; and Date of Creation: Jul. 22, 2024) are herein incorporated by reference in their entirety.

### BACKGROUND

Halitosis, commonly known as bad breath, is an oral health issue that affects several mammalian species, including humans and dogs. Halitosis is characterized by the buildup of compounds within the oral cavity, which emit a strong, offensive odor. The main malodorous compounds are volatile sulfur compounds (VSCs). These compounds are byproducts of bacterial metabolism. VSCs include hydrogen sulfide, methyl mercaptan, and dimethyl sulfide, all of which give off strong and unpleasant odors.

### SUMMARY

Some aspects relate to compositions comprising fermentate(s) of bacterial strains. Some aspects relate to methods of using compositions comprising fermentate(s) of bacterial strains. Such compositions and methods are based, at least in part, on the recognition that bacterial strains and fermentates thereof are able to effectively decrease volatile sulfur compounds (VSCs), which are associated with halitosis, and disrupt biofilms of VSC-producing microorganisms, thereby inhibiting continued VSC production by such microbes. While such fermentates alone are useful for reduction of VSC abundance, compositions may also comprise additional fermentates of other bacterial strains useful in treating or preventing halitosis.

For example, a composition described herein may comprise a fermentate of a bacterial strain that disrupts a biofilm of a canine oral microbe (e.g., Neisseria canis), thereby reducing the abundance of canine oral microbes and reducing ongoing VSC production by such microbes. A composition described herein may comprise a fermentate of a bacterial strain that produces an antioxidant, which can absorb free radicals of VSCs, thereby mitigating VSCs' contribution to malodor. A composition described herein may comprise a fermentate of a bacterial strain that enhances the function of one or more other bacterial strains or fermentates, such as their ability to reduce VSC abundance, inhibit VSC production, disrupt biofilms, and/or absorb free radicals of VSCs. A composition described herein may further comprise one or more additional components, such as vitamins, organic acids, a polyphenols, indole-containing compounds, and phenols. In addition to the benefits of organic acids in reducing the oral microenvironment pH, thereby hindering VSC production and/or growth of VSC-producing microorganisms, such additional components may enhance the VSC-reducing ability of bacterial strains present in a composition.

Accordingly, some aspects of the present disclosure relate to a postbiotic composition comprising (a) a fermentate of a first bacterial strain comprising a 16S rDNA sequence with at least 97% sequence identity to the nucleic acid sequence of any one of SEQ ID NOs: 1-4; and (b) one or more additional fermentates, wherein each of the one or more additional fermentates are of a bacterial strain comprising a 16S rDNA sequence with at least 97% sequence identity to the nucleic acid sequence of any one of SEQ ID NO: 5-9.

In some embodiments, the bacterial strain of (a) is capable of disrupting a biofilm of one or more canine oral microbes. In some embodiments, the bacterial strain of (b) is capable of (i) producing one or more compounds able to reduce the abundance of one or more volatile sulfur compounds (VSCs); (ii) producing one or more antioxidants; (iii) enhancing a function of one or more bacterial strains. In some embodiments, the antioxidant is selected from the group consisting of a vitamin, an organic acid, a polyphenol, an indole-containing compound, and a phenol. In some embodiments, the antioxidant is reactive to the ferric ion-reducing antioxidant power assay.

Some aspects relate to a postbiotic composition comprising (a) a first fermentate of a first bacterial strain comprising a 16S rDNA sequence with at least 97% sequence identity to the nucleic acid sequence of any one of SEQ ID NOs: 1-4; and (b) a second fermentate of a second bacterial strain comprising a 16S rDNA sequence with at least 97% sequence identity to the nucleic acid sequence of SEQ ID NO: 5. In some embodiments, the composition further comprises (c) a third fermentate of a third bacterial strain comprising a 16s rDNA sequence with at least 97% sequence identity to the nucleic acid sequence of any one of SEQ ID NOs: 6-9.

In some embodiments, (a) the first bacterial strain comprises a 16S rDNA sequence with at least 97% sequence identity to the nucleic acid sequence of SEQ ID NO: 1; (b) the second bacterial strain comprises a 16S rDNA sequence with at least 97% sequence identity to the nucleic acid sequence of SEQ ID NO: 5; and (c) the third bacterial strain comprises a 16S rDNA sequence with at least 97% sequence identity to the nucleic acid sequence of SEQ ID NO: 6.

In some embodiments, (a) the first bacterial strain comprises a 16S rDNA sequence with at least 97% sequence identity to the nucleic acid sequence of SEQ ID NO: 1; (b) the second bacterial strain comprises a 16S rDNA sequence with at least 97% sequence identity to the nucleic acid sequence of SEQ ID NO: 5; and (c) the third bacterial strain comprises a 16S rDNA sequence with at least 97% sequence identity to the nucleic acid sequence of SEQ ID NO: 9.

Some aspects relate to a postbiotic composition comprising (a) a first fermentate of a first bacterial strain comprising a 16S rDNA sequence with at least 97% sequence identity to the nucleic acid sequence of any one of SEQ ID NOs: 1-4; and (b) a second fermentate of a second bacterial strain comprising a 16S rDNA sequence with at least 97% sequence identity to the nucleic acid sequence of any one of SEQ ID NOs: 6-9. In some embodiments, the composition further comprises a third fermentate of a third bacterial strain comprising a 16s rDNA sequence with at least 97% sequence identity to the nucleic acid sequence of SEQ ID NO: 5.

In some embodiments, (a) the first bacterial strain comprises a 16S rDNA sequence with at least 97% sequence identity to the nucleic acid sequence of SEQ ID NO: 1; (b) the second bacterial strain comprises a 16S rDNA sequence with at least 97% sequence identity to the nucleic acid sequence of SEQ ID NO: 5; and (c) the third bacterial strain comprises a 16S rDNA sequence with at least 97% sequence identity to the nucleic acid sequence of SEQ ID NO: 6.

Some aspects relate to a postbiotic composition comprising: (a) a fermentate of a bacterial strain that disrupts an oral biofilm; and at least one of: (b)(i) a fermentate of a bacterial strain that produces one or more compounds able to reduce the abundance of one or more volatile sulfur compounds (VSCs), (b)(ii) a fermentate of a bacterial strain that produces one or more antioxidants; and (b)(iii) a fermentate of a bacterial strain that enhances a function of one or more bacterial strains.

In some embodiments, the bacterial strain of (a) is selected from the group consisting of Bacillus subtilis, Bacillus amyloliquefaciens, Bacillus licheniformis, and Bacillus pumilus. In some embodiments, the bacterial strain of (b)(i) is Pediococcus pentosaceus. In some embodiments, the bacterial strain of (b)(i) is selected from the group consisting of Pediococcus pentosaceus, Bacillus subtilis, and Lactiplantibacillus plantarum. In some embodiments, the bacterial strain of (b)(ii) is selected from the group consisting of Lactiplantibacillus plantarum, Lactobacillus delbrueckii, and Limosilactobacillus fermentum. In some embodiments, the bacterial strain of (b)(ii) is selected from the group consisting of Pediococcus pentosaceus, Lactiplantibacillus plantarum, Lactobacillus delbrueckii, and Limosilactobacillus fermentum.

In some embodiments, the bacterial strain of (iii) is selected from the group consisting of Bacillus subtilis and Lactiplantibacillus plantarum.

In some embodiments, composition reduces the abundance of one or more volatile sulfur compounds (VSCs) in an oral cavity of a subject. In some embodiments, the composition reduces the abundance of one or more volatile sulfur compound (VSC)-producing microorganisms in a subject. In some embodiments, the one or more VSC-producing microorganisms are selected from the group consisting of Fusobacterium nucleatum, Neisseria canis, Bergyella zoohelcum, Prevotella intermedia, Porphyromonas canigingivalis, Porphyromonas gingivalis, Tannerella forsythia, and Treponema denticola.

In some embodiments, the one or more VSCs are selected from the group consisting of hydrogen sulfide, methyl mercaptan, and dimethyl sulfide. In some embodiments, the composition reduces the level of gum inflammation, gingivitis, plaque, tartar, and/or dental calculus accumulation in an oral cavity of a subject. In some embodiments, the composition treats or prevents one or more symptom of halitosis in a subject. In some embodiments, each of the fermentates are in powdered form. In some embodiments, each of the fermentates are lyophilized or spray-dried.

In some embodiments, each fermentate is present in an amount of 1 to 500 mg. In some embodiments, the composition comprises a total amount of fermentate in an amount of 1 to 500 mg.

In some embodiments, the composition further comprises a carrier. In some embodiments, the carrier is maltodextrin. In some embodiments, the carrier is a tapioca-based maltodextrin.

Some aspects relate to a nutritional supplement, dental supplement, or food product comprising the composition.

Some aspects relate to a nutritional supplement, dental supplement, or food product comprising the composition at an incorporation rate of 0.01% to 10% [w/w]. Some aspects relate to a nutritional supplement, dental supplement, or food product comprising the composition at an incorporation rate of 0.1% to 2% [w/w].

In some embodiments, the nutritional supplement is a canine nutritional supplement. In some embodiments, the dental supplement is a canine nutritional supplement. In some embodiments, the nutritional supplement, dental supplement, or food product comprises a meat or animal-derived material. In some embodiments, the meat or animal-derived material is beef, chicken, eggs, turkey, lamb, fish, blood marrow, and/or bone marrow.

In some embodiments, the nutritional supplement, dental supplement, or food product further comprises a grain. In some embodiments, the grain is wheat, corn, rice, oats, and/or barley.

In some embodiments, the nutritional supplement, dental supplement, or food product further comprises a fiber. In some embodiments, the fiber is sugar beet pulp, chicory pulp, chicory, coconut endosperm fiber, wheat fiber, fructooligosaccharides, galactooligosaccharides, and/or inulin.

In some embodiments, the nutritional supplement, dental supplement, or food product further comprises algae. In some embodiments, the algae belongs to a species selected from the group consisting of Ascophyllum nodosum, Spirulina, and Fucus vesiculosus.

In some embodiments, the nutritional supplement, dental supplement, or food product further comprises a gelatinized starch matrix.

In some embodiments, the nutritional supplement, dental supplement, or food product reduces inflammation in a subject. In some embodiments, the nutritional supplement, dental supplement, or food product treats or prevents a symptom associated with halitosis in a subject. In some embodiments, the dental supplement is an extruded or injection-molded dental stick. In some embodiments, the dental supplement is an extruded or injection-molded dental chew. In some embodiments, the nutritional supplement or dental supplement is a chew having a soft interior.

In some embodiments, the nutritional supplement is a meal topper. In some embodiments, the nutritional supplement is a water additive. In some embodiments, the food product is an extruded kibble. In some embodiments, the food product is a fresh food. In some embodiments, the nutritional supplement is a liquid spray. In some embodiments, the nutritional supplement or food product is peanut butter spread. In some embodiments, the nutritional supplement, dental supplement, or food product is soft jerky chew.

Some aspects relate to a method comprising a composition, nutritional supplement, dental supplement, or food product to a subject. In some embodiments, the administration is oral administration (e.g., consumption of the composition, nutritional supplement, dental supplement, or food product) by the subject. In some embodiments, the subject has halitosis.

In some embodiments, an oral microenvironment of the subject comprises one or more bacterial strains selected from Porphyromonas gingivalis, Prevotella intermedia, Porphyromonas canigingivalis, Tannerella forsythia, Treponema denticola, Fusobacterium nucleatum, Neisseria canis, and Bergeyella zoohelcum.

In some embodiments, administration of the composition, nutritional supplement, dental supplement, or food product: (i) reduces the abundance of one or more VSCs in an oral microenvironment of the subject; (ii) reduces inflammation in the oral microenvironment of the subject; (iii) reduces the abundance of gingivitis, plaque, tartar, and/or dental calculus in the subject; (iv) reduces the abundance of one or more microorganisms associated with the production of VSCs; (v) reduces one or more symptom associated with halitosis; and/or (vi) improves oral health of the subject.

In some embodiments, the subject is a carnivore. In some embodiments, the subject is a mammal. In some embodiments, the subject is a domesticated animal. In some embodiments, the subject is a bovine, swine, llama, alpaca, sheep, or goat. In some embodiments, the subject is a dog, cat, rabbit, guinea pig, hamster, or ferret. In some embodiments, the subject is a dog.

### BRIEF DESCRIPTION OF THE DRAWINGS

The accompanying drawings, which constitute a part of this specification, illustrate several embodiments of the disclosure and together with the description, serve to explain the principles of the disclosure.

FIG. 1 shows effects of fermentate compositions on VSC production Fusobacterium nucleatum, a known canine oral microbe.

FIG. 2 shows dose response of fermentate compositions on reduction of VSC production by F. nucleatum. “Dose A” corresponds to a 0.3× dose; “Dose B” corresponds to a 1× dose; and “Dose C” corresponds to 3× dose.

FIG. 3 shows disruption of biofilm of canine oral microbes by fermentate composition.

FIG. 4 shows disruption of biofilm of canine oral microbes by separate individual fermentates of Bacillus subtilis. Biofilm area after treatment with each fermentate is normalized to area following treatment with negative control (media only).

### DETAILED DESCRIPTION

Aspects of the disclosure relate to compositions, nutritional supplements, dental supplements, and/or food products comprising fermentates of one or more bacterial strains that reduce levels of volatile sulfur compounds (VSCs) in environment, inhibit VSC production by other microorganisms, and/or disrupt biofilms of VSC-producing microorganisms, and methods of use thereof. Without wishing to be bound by theory, the compositions comprising fermentates described herein are useful for reducing VSC abundance, which is associated with halitosis. Fermentates of other bacterial strains may further enhance the VSC-reducing and/or halitosis-alleviating properties of such compositions, such as by inhibiting VSC production, producing or providing antioxidants that absorb free radicals of VSCs, disrupting biofilms of VSC-producing microbes, and/or reducing or slowing accumulation of plaque, tartar, or dental calculus.

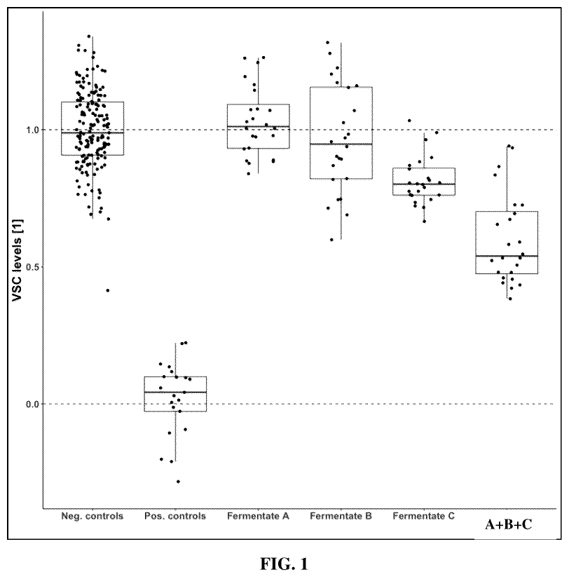

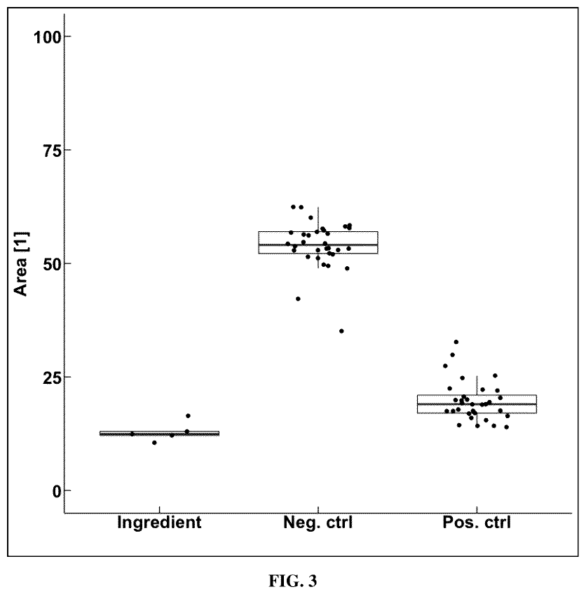

Compositions comprising fermentates of microbes such as Bacillus subtilis, Pediococcus pentosaceus, and/or Lactobacillus plantarum (among others) were found to be effective in reducing the abundance of VSCs produced by microbes associated with halitosis (e.g., Fusobacterium nucleatum), with synergistic reductions being observed when fermentates from multiple species were combined (FIG. 1). Furthermore, fermentates disrupted biofilms of other canine oral microbes associated with halitosis (e.g., Neisseria canis and Bergeyella zoohelcum) (FIG. 3). Thus, compositions containing fermentates may be useful, for example, in mitigating growth of oral microbes associated with VSC production and other consequences of unmediated halitosis, such as plaque and dental calculus accumulation.

Compositions comprising bacterial fermentates may be in any suitable form, such as a dry powder that may be combined with other compositions (e.g., combination with food prior to a meal) or in liquid form that may be added to water or combined with other compositions (e.g., combined with or applied to food prior to a meal). Compositions comprising bacterial fermentates may also be present as part of another composition, such as a pill, capsule, tablet, chewable matrix, nutritional supplement, dental supplement, and/or food product.

This disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

### Bacterial Strains and Fermentates Thereof

Some aspects relate to compositions (and/or nutritional supplements, dental supplements, and/or food products comprising a composition) comprising (a) a fermentate of a first bacterial strain comprising a 16S rDNA sequence with at least 97% sequence identity to a nucleotide sequence of any one of SEQ ID NOs: 1-4; and (b) one or more additional fermentates, each being a fermentate of a bacterial strain comprising a 16S rDNA sequence with at least 97% sequence identity to a nucleotide sequence of any one of SEQ ID NOs: 5-9.

Some aspects relate to compositions (and/or nutritional supplements, dental supplements, and/or food products comprising a composition) comprising (a) a fermentate of a first bacterial strain belonging to a species selected from the group consisting of Bacillus subtilis, Bacillus amyloliquefaciens, Bacillus licheniformis, and Bacillus pumilus; and one or more additional fermentates, each being a fermentate of a bacterial strain belonging to a species selected from the group consisting of Pediococcus pentosaceus, Lactiplantibacillus plantarum, Lactobacillus delbrueckii, Limosilactobacillus fermentum, and Bacillus subtilis, where the Bacillus subtilis strain producing additional fermentate is different from the Bacillus subtilis producing the first fermentate.

Some aspects relate to compositions (and/or nutritional supplements, dental supplements, and/or food products comprising a composition) comprising (a) a first fermentate of a first bacterial strain comprising a 16S rDNA sequence with at least 97% sequence identity to a nucleotide sequence of any one of SEQ ID NOs: 1-4; and (b) a second fermentate of a second bacterial strain comprising a 16S rDNA sequence comprising a 16S rDNA sequence with at least 97% sequence identity to a nucleotide sequence of SEQ ID NO: 5. In some embodiments, the composition comprises (a) a first fermentate of a first bacterial strain comprising a 16S rDNA sequence with at least 97% sequence identity to a nucleotide sequence of SEQ ID NO: 1. In some embodiments, the composition comprises (a) a first fermentate of a first bacterial strain comprising a 16S rDNA sequence with at least 97% sequence identity to a nucleotide sequence of SEQ ID NO: 2. In some embodiments, the composition comprises (a) a first fermentate of a first bacterial strain comprising a 16S rDNA sequence with at least 97% sequence identity to a nucleotide sequence of SEQ ID NO: 3. In some embodiments, the composition comprises (a) a first fermentate of a first bacterial strain comprising a 16S rDNA sequence with at least 97% sequence identity to a nucleotide sequence of SEQ ID NO: 4.

Some aspects relate to compositions (and/or nutritional supplements, dental supplements, and/or food products comprising a composition) comprising (a) a first fermentate of a first bacterial strain belonging to a species selected from the group consisting of Bacillus subtilis, Bacillus amyloliquefaciens, Bacillus licheniformis, and Bacillus pumilus; and (b) a second fermentate of a second bacterial strain belonging to Pediococcus pentosaceus. In some embodiments, the composition comprises a first fermentate of a first bacterial strain belonging to Bacillus subtilis. In some embodiments, the composition comprises a first fermentate of a first bacterial strain belonging to Bacillus amyloliquefaciens. In some embodiments, the composition comprises a first fermentate of a first bacterial strain belonging to Bacillus licheniformis. In some embodiments, the composition comprises a first fermentate of a first bacterial strain belonging to Bacillus pumilus.

In some embodiments, the composition comprises (a) a first fermentate of a first bacterial strain comprising a 16S rDNA sequence with at least 97% sequence identity to a nucleotide sequence of SEQ ID NO: 1; (b) a second fermentate of a second bacterial strain comprising a 16S rDNA sequence comprising a 16S rDNA sequence with at least 97% sequence identity to a nucleotide sequence of SEQ ID NO: 5; and (c) a third fermentate of a third bacterial strain comprising a 16S rDNA sequence comprising a 16S rDNA sequence with at least 97% sequence identity to a nucleotide sequence of SEQ ID NO: 6.

In some embodiments, the composition comprises (a) a first fermentate of a first bacterial strain belonging to Bacillus subtilis; (b) a second fermentate of a second bacterial strain belonging to Pediococcus pentosaceus; and (c) a third fermentate of a third bacterial strain belonging to Lactobacillus plantarum.

In some embodiments, the composition comprises (a) a first fermentate of a first bacterial strain comprising a 16S rDNA sequence with at least 97% sequence identity to a nucleotide sequence of SEQ ID NO: 1; (b) a second fermentate of a second bacterial strain comprising a 16S rDNA sequence comprising a 16S rDNA sequence with at least 97% sequence identity to a nucleotide sequence of SEQ ID NO: 5; and (c) a third fermentate of a third bacterial strain comprising a 16S rDNA sequence comprising a 16S rDNA sequence with at least 97% sequence identity to a nucleotide sequence of SEQ ID NO: 9.

In some embodiments, the composition comprises (a) a first fermentate of a first bacterial strain belonging to Bacillus subtilis; (b) a second fermentate of a second bacterial strain belonging to Pediococcus pentosaceus; and (c) a third fermentate of a third bacterial strain belonging to Bacillus subtilis that is different from the first Bacillus subtilis strain.

Some aspects relate to compositions (and/or nutritional supplements, dental supplements, and/or food products comprising a composition) comprising (a) a first fermentate of a first bacterial strain comprising a 16S rDNA sequence with at least 97% sequence identity to a nucleotide sequence of any one of SEQ ID NOs: 1-4; and (b) a second fermentate of a second bacterial strain comprising a 16S rDNA sequence with at least 97% sequence identity to a nucleotide sequence of any one of SEQ ID NOs: 6-9.

Some aspects relate to compositions (and/or nutritional supplements, dental supplements, and/or food products comprising a composition) comprising (a) a first fermentate of a first bacterial strain belonging to a species selected from the group consisting of Bacillus subtilis, Bacillus amyloliquefaciens, Bacillus licheniformis, and Bacillus pumilus; and (b) a second fermentate of a second bacterial strain belonging to a species selected from the group consisting of Lactiplantibacillus plantarum, Lactobacillus delbrueckii, Limosilactobacillus fermentum, and Bacillus subtilis, where the Bacillus subtilis strain producing the second fermentate is different from the Bacillus subtilis producing the first fermentate.

In some embodiments, the composition comprises (a) a first fermentate of a first bacterial strain comprising a 16S rDNA sequence with at least 97% sequence identity to a nucleotide sequence of SEQ ID NO: 1, and (b) a second fermentate of a second bacterial strain comprising a 16S rDNA sequence with at least 97% sequence identity to a nucleotide sequence of SEQ ID NO: 6. In some embodiments, the composition comprises (a) a first fermentate of a first bacterial strain comprising a 16S rDNA sequence with at least 97% sequence identity to a nucleotide sequence of SEQ ID NO: 1, and (b) a second fermentate of a second bacterial strain comprising a 16S rDNA sequence with at least 97% sequence identity to a nucleotide sequence of SEQ ID NO: 7. In some embodiments, the composition comprises (a) a first fermentate of a first bacterial strain comprising a 16S rDNA sequence with at least 97% sequence identity to a nucleotide sequence of SEQ ID NO: 1, and (b) a second fermentate of a second bacterial strain comprising a 16S rDNA sequence with at least 97% sequence identity to a nucleotide sequence of SEQ ID NO: 8. In some embodiments, the composition comprises (a) a first fermentate of a first bacterial strain comprising a 16S rDNA sequence with at least 97% sequence identity to a nucleotide sequence of SEQ ID NO: 1, and (b) a second fermentate of a second bacterial strain comprising a 16S rDNA sequence with at least 97% sequence identity to a nucleotide sequence of SEQ ID NO: 9.

In some embodiments, the composition comprises (a) a first fermentate of a first bacterial strain belonging to Bacillus subtilis; and (b) a second fermentate of a second bacterial strain belonging to Lactiplantibacillus plantarum. In some embodiments, the composition comprises (a) a first fermentate of a first bacterial strain belonging to Bacillus subtilis; and (b) a second fermentate of a second bacterial strain belonging to Lactobacillus delbrueckii. In some embodiments, the composition comprises (a) a first fermentate of a first bacterial strain belonging to Bacillus subtilis; and (b) a second fermentate of a second bacterial strain belonging to Limosilactobacillus fermentum. In some embodiments, the composition comprises (a) a first fermentate of a first bacterial strain belonging to Bacillus subtilis; and (b) a second fermentate of a second bacterial strain belonging to Bacillus subtilis that is different from the first Bacillus subtilis strain.

In some embodiments, the composition further comprises a third fermentate of a third bacterial strain comprising a 16S rDNA sequence with at least 97% sequence identity to a nucleotide sequence of SEQ ID NO: 5. In some embodiments, the composition comprises (a) a first fermentate of a first bacterial strain comprising a 16S rDNA sequence with at least 97% sequence identity to a nucleotide sequence of SEQ ID NO: 1; (b) a second fermentate of a second bacterial strain comprising a 16S rDNA sequence comprising a 16S rDNA sequence with at least 97% sequence identity to a nucleotide sequence of SEQ ID NO: 5; and (c) a third fermentate of a third bacterial strain comprising a 16S rDNA sequence comprising a 16S rDNA sequence with at least 97% sequence identity to a nucleotide sequence of SEQ ID NO: 6.

In some embodiments, the composition further comprises a third fermentate of a third bacterial strain belonging to Pediococcus pentosaceus. In some embodiments, the composition comprises (a) a first fermentate of a first bacterial strain belonging to Bacillus subtilis; (b) a second fermentate of a second bacterial strain belonging to Pediococcus pentosaceus; and (c) a third fermentate of a third bacterial strain belonging to Lactiplantibacillus plantarum.

Some aspects relate to compositions (and/or nutritional supplements and/or dental supplements and/or food products comprising a composition) comprising (a) a fermentate of a bacterial strain that disrupts a biofilm of an oral microbe; and (b) at least one of (i) a fermentate of a bacterial strain that produces one or more compounds that are able to reduce the abundance of one or more volatile sulfur compounds (VSCs); (ii) a fermentate of a bacterial strain that produces one or more antioxidants; and/or (iii) a fermentate of a bacterial strain that enhances a function of one or more other bacterial strains that are sources of other fermentates in the composition.

In some embodiments, a bacterial strain from which a fermentate is obtained is capable of (i) producing one or more compounds that are able to reduce the abundance of one or more volatile sulfur compounds (VSCs); (ii) producing one or more antioxidants; and/or (iii) enhancing a function of one or more other bacterial strains that are sources of other fermentates of the composition.

In some embodiments, the bacterial strain from which a fermentate is obtained is capable of producing one or more compounds that are able to reduce the abundance of one or more VSCs. In some embodiments, the bacterial strain is selected from the group consisting of Bacillus subtilis, Bacillus amyloliquefaciens, Bacillus licheniformis, and Bacillus pumilus. In some embodiments, the bacterial strain comprises a 16S rDNA sequence with at least 97% sequence identity to any one of SEQ ID NOs: 1-4 and 9. In some embodiments, the bacterial strain is selected from the group consisting of Pediococcus pentosaceus, Bacillus subtilis, and Lactiplantibacillus plantarum. In some embodiments, the bacterial strain comprises a 16S rDNA sequence with at least 97% sequence identity to any one of SEQ ID NOs: 1, 5, 6, and 9. In some embodiments, the bacterial strain is Bacillus subtilis. In some embodiments, the bacterial strain comprises a 16S rDNA sequence with at least 97% sequence identity to SEQ ID NO: 1 or 9. In some embodiments, the bacterial strain comprises a 16S rDNA sequence with at least 97% sequence identity to SEQ ID NO: 1. In some embodiments, the bacterial strain comprises a 16S rDNA sequence with at least 97% sequence identity to SEQ ID NO: 9. In some embodiments, the bacterial strain is Bacillus amyloliquefaciens. In some embodiments, the bacterial strain comprises a 16S rDNA sequence with at least 97% sequence identity to SEQ ID NO: 2. In some embodiments, the bacterial strain is Bacillus licheniformis. In some embodiments, the bacterial strain comprises a 16S rDNA sequence with at least 97% sequence identity to SEQ ID NO: 3. In some embodiments, the bacterial strain is Bacillus pumilus. In some embodiments, the bacterial strain comprises a 16S rDNA sequence with at least 97% sequence identity to SEQ ID NO: 4. In some embodiments, the bacterial strain is Pediococcus pentosaceus. In some embodiments, the bacterial strain comprises a 16S rDNA sequence with at least 97% sequence identity to SEQ ID NO: 5. In some embodiments, the bacterial strain is Lactiplantibacillus plantarum. In some embodiments, the bacterial strain comprises a 16S rDNA sequence with at least 97% sequence identity to SEQ ID NO: 6.

In some embodiments, the bacterial strain from which a fermentate is obtained is capable of producing one or more antioxidants. In some embodiments, the antioxidant is selected from the group consisting of a vitamin, an organic acid, a polyphenol, an indole-containing compound, and a phenol. In some embodiments, the antioxidant is reactive to the ferric ion-reducing antioxidant power assay. See, e.g., Benzie and Strain, Methods Enzymol. 1999. 299:15-27.

In some embodiments, the antioxidant is a vitamin. In some embodiments, the vitamin is selected from vitamin A, vitamin C, vitamin B1, B2, B6, B12, vitamin D3, vitamin E, and vitamin K.

In some embodiments, the antioxidant is an organic acid. In some embodiments, the organic acid is selected from the group consisting of lactic acid, ascorbic acid, acetic acid, acrylic acid, propionic acid, pyruvic acid, and citric acid.

In some embodiments, the antioxidant is a polyphenol. In some embodiments, the polyphenol is selected from the group consisting of green tea polyphenols, tannins, resveratrol, flavonoids, and anthocyanins.

In some embodiments, the antioxidant is an indole-containing compound. In some embodiments, the indole-containing compound is selected from the group consisting of indoleacrylic acid, indolepropionic acid, indoleacetic acid, indole-3-carbinol, indole-3-acetamine, indolealdehyde, indolelactic acid, indolepyruvate, tryptophol, and indole.

In some embodiments, the antioxidant is a phenol.

In some embodiments, the bacterial strain that is capable of producing one or more antioxidants is selected from the group consisting of Lactiplantibacillus plantarum, Lactobacillus delbrueckii, and Limosilactobacillus fermentum. In some embodiments, the bacterial strain that is capable of producing one or more antioxidants comprises a 16S rDNA sequence with at least 97% sequence identity to any one of SEQ ID NOs: 6-8. In some embodiments, the bacterial strain that is capable of producing one or more antioxidants is selected from the group consisting of Pediococcus pentosaceus, Lactiplantibacillus plantarum, Lactobacillus delbrueckii, and Limosilactobacillus fermentum. In some embodiments, the bacterial strain that is capable of producing one or more antioxidants comprises a 16S rDNA sequence with at least 97% sequence identity to any one of SEQ ID NOs: 5-8. In some embodiments, the bacterial strain is Lactiplantibacillus plantarum. In some embodiments, the bacterial strain comprises a 16S rDNA sequence with at least 97% sequence identity to SEQ ID NO: 6. In some embodiments, the bacterial strain is Lactobacillus delbrueckii. In some embodiments, the bacterial strain comprises a 16S rDNA sequence with at least 97% sequence identity to SEQ ID NO: 7. In some embodiments, the bacterial strain is Limosilactobacillus fermentum. In some embodiments, the bacterial strain comprises a 16S rDNA sequence with at least 97% sequence identity to SEQ ID NO: 8. In some embodiments, the bacterial strain is Pediococcus pentosaceus. In some embodiments, the bacterial strain comprises a 16S rDNA sequence with at least 97% sequence identity to SEQ ID NO: 5.

In some embodiments, the bacterial strain from which a fermentate is obtained is capable of enhancing a function of one or more other bacterial strains that are sources of other fermentates of the composition. In some embodiments, the bacterial strain is selected from Bacillus subtilis and Lactiplantibacillus plantarum. In some embodiments, the bacterial strain comprises a 16S rDNA sequence identity to any one of SEQ ID NOs: 1, 6, or 9.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 1. In some embodiments, the bacterial strain comprising a 16S rDNA sequence with at least 97% sequence identity to SEQ ID NO: 1 belongs to the species Bacillus subtilis.

In some embodiments, a bacterial strain, e.g., that produces a fermentate, has a 16S rDNA 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 2. In some embodiments, the bacterial strain comprising a 16S rDNA sequence with at least 97% sequence identity to SEQ ID NO: 2 belongs to the species Bacillus amyloliquefaciens.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 3. In some embodiments, the bacterial strain comprising a 16S rDNA sequence with at least 97% sequence identity to SEQ ID NO: 3 belongs to the species Bacillus licheniformis.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 4. In some embodiments, the bacterial strain comprising a 16S rDNA sequence with at least 97% sequence identity to SEQ ID NO: 4 belongs to the species Bacillus pumilus.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 5. In some embodiments, the bacterial strain comprising a 16S rDNA sequence with at least 97% sequence identity to SEQ ID NO: 5 belongs to the species Pediococcus pentosaceus.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 6. In some embodiments, the bacterial strain comprising a 16S rDNA sequence with at least 97% sequence identity to SEQ ID NO: 6 belongs to the species Lactiplantibacillus plantarum.

In some embodiments, a bacterial strain, e.g., that produces a fermentate, has a 16S rDNA 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 7. In some embodiments, the bacterial strain comprising a 16S rDNA sequence with at least 97% sequence identity to SEQ ID NO: 7 belongs to the species Lactobacillus delbrueckii.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 8. In some embodiments, the bacterial strain comprising a 16S rDNA sequence with at least 97% sequence identity to SEQ ID NO: 8 belongs to the species Limosilactobacillus fermentum.

In some embodiments, a bacterial strain, e.g., that produces a fermentate, has a 16S rDNA sequence with at least 97.0%, 97.1%, 97.2%, 97.3%, 97.4%, 97.5%, 97.6%, 97.7%, 97.8%, 97.9%, 98.0%, 98.1%, 98.2%, 98.3%, 98.4%, 98.5%, 98.6%, 98.7%, 98.8%, 98.9%, 99.0%, 99.1%, 99.2%, 99.3%, 99.4%, 99.5%, 99.6%, 99.7%, 99.8%, 99.9%, or 100% identity to SEQ ID NO: 9. In some embodiments, the bacterial strain comprising a 16S rDNA sequence with at least 97% sequence identity to SEQ ID NO: 9 belongs to the species Bacillus subtilis.

The bacterial strain comprising a 16S rDNA sequence provided by SEQ ID NO: 1 (also
referred to herein as “Strain 1”) has the highest homology with a bacterial strain of the species
Bacillus subtilis:
Strain 1 16S ribosomal RNA coding sequence (16S rDNA)
(SEQ ID NO: 1)
ATGTTAGCGGCGGACGGGTGAGTAACACGTGGGTAACCTGCCTGTAAGACTGGGATAACTCCGGGAAACCGGGGCTA
ATACCGGATGGTTGTTTGAACCGCATGGTTCAAACATAAAAGGTGGCTTCGGCTACCACTTACAGATGGACCCGCGG
CGCATTAGCTAGTTGGTGAGGTAACGGCTCACCAAGGCAACGATGCGTAGCCGACCTGAGAGGGTGATCGGCCACAC
TGGGACTGAGACACGGCCCAGACTCCTACGGGAGGCAGCAGTAGGGAATCTTCCGCAATGGACGAAAGTCTGACGGA
GCAACGCCGCGTGAGTGATGAAGGTTTTCGGATCGTAAAGCTCTGTTGTTAGGGAAGAACAAGTACCGTTCGAATAG
GGCGGTACCTTGACGGTACCTAACCAGAAAGCCACGGCTAACTACGTGCCAGCAGCCGCGGTAATACGTAGGTGGCA
AGCGTTGTCCGGAATTATTGGGCGTAAAGGGCTCGCAGGCGGTTTCTTAAGTCTGATGTGAAAGCCCCCGGCTCAAC
CGGGGAGGGTCATTGGAAACTGGGGAACTTGAGTGCAGAAGAGGAGAGTGGAATTCCACGTGTAGCGGTGAAATGCG
TAGAGATGTGGAGGAACACCAGTGGCGAAGGCGACTCTCTGGTCTGTAACTGACGCTGAGGAGCGAAAGCGTGGGGA
GCGAACAGGATTAGATACCCTGGTAGTCCACGCCGTAAACGATGAGTGCTAAGTGTTAGGGGGTTTCCGCCCCTTAG
TGCTGCAGCTAACGCATTAAGCACTCCGCCTGGGGAGTACGGTCGCAAGACTGAAACTCAAAGGAATTGACGGGGGC
CCGCACAAGCGGTGGAGCATGTGGTTTAATTCGAAGCAACGCGAAGAACCTTACCAGGTCTTGACATCCTCTGACAA
TCCTAGAGATAGGACGTCCCCTTCGGGGGCAGAGTGACAGGTGGTGCATGGTTGTCGTCAGCTCGTGTCGTGAGATG
TTGGGTTAAGTCCCGCAACGAGCGCAACCCTTGATCTTAGTTGCCAGCATTCAGTTGGGCACTCTAAGGTGACTGCC
GGTGACAAACCGGAGGAAGGTGGGGATGACGTCAAATCATCATGCCCCTTATGACCTGGGCTACACACGTGCTACAA
TGGACAGAACAAAGGGCAGCGAAACCGCGAGGTTAAGCCAATCCCACAAATCTGTTCTCAGTTCGGATCGCAGTCTG
CAACTCGACTGCGTGAAGCTGGAATCGCTAGTAATCGCGGATCAGCATGCCGCGGTGAATACGTTCCCGGGCCTTGT
ACACACCGCCCGTCACACCACGAGAGTTTGTAACACCCGAAGTCGGTGAGGTAACCTTTTAGGAGCCAGCCGCCGAA
GGTGGGACAGATGATTGGGGTGAAGTCGTAACAAGGTAGCCGTATCGGAAGGTGCGGCTGGATCACCTCCTTT
The bacterial strain comprising a 16S rDNA sequence provided by SEQ ID NO: 2 (also
referred to herein as “Strain 2”) has the highest homology with a bacterial strain of the species
Bacillus amyloliquefaciens:
Strain 2 16S ribosomal RNA coding sequence (16S rDNA)
(SEQ ID NO: 2)
CGGAGAGTTTGATCCTGGCTCAGGACGAACGCTGGCGGCGTGCCTAATACATGCAAGTCGAGCGGACAGATGGGAGC
TTGCTCCCTGATGTTAGCGGCGGACGGGTGAGTAACACGTGGGTAACCTGCCTGTAAGACTGGGATAACTCCGGGAA
ACCGGGGCTAATACCGGATGCTTGTTTGAACCGCATGGTTCAAACATAAAAGGTGGCTTCGGCTACCACTTACAGAT
GGACCCGCGGCGCATTAGCTAGTTGGTGAGGTAACGGCTCACCAAGGCGACGATGCGTAGCCGACCTGAGAGGGTGA
TCGGCCACACTGGGACTGAGACACGGCCCAGACTCCTACGGGAGGCAGCAGTAGGGAATCTTCCGCAATGGACGAAA
GTCTGACGGAGCAACGCCGCGTGAGTGATGAAGGTTTTCGGATCGTAAAGCTCTGTTGTTAGGGAAGAACAAGTGCC
GTTCAAATAGGGCGGCACCTTGACGGTACCTAACCAGAAAGCCACGGCTAACTACGTGCCAGCAGCCGCGGTAATAC
GTAGGTGGCAAGCGTTGTCCGGAATTATTGGGCGTAAAGGGCTCGCAGGCGGTTTCTTAAGTCTGATGTGAAAGCCC
CCGGCTCAACCGGGGAGGGTCATTGGAAACTGGGGAACTTGAGTGCAGAAGAGGAGAGTGGAATTCCACGTGTAGCG
GTGAAATGCGTAGAGATGTGGAGGAACACCAGTGGCGAAGGCGACTCTCTGGTCTGTAACTGACGCTGAGGAGCGAA
AGCGTGGGGAGCGAACAGGATTAGATACCCTGGTAGTCCACGCCGTAAACGATGAGTGCTAAGTGTTAGGGGGTTTC
CGCCCCTTAGTGCTGCAGCTAACGCATTAAGCACTCCGCCTGGGGAGTACGGTCGCAAGACTGAAACTCAAAGGAAT
TGACGGGGGCCCGCACAAGCGGTGGAGCATGTGGTTTAATTCGAAGCAACGCGAAGAACCTTACCAGGTCTTGACAT
CCTCTGACAATCCTAGAGATAGGACGTCCCCTTCGGGGGCAGAGTGACAGGTGGTGCATGGTTGTCGTCAGCTCGTG
TCGTGAGATGTTGGGTTAAGTCCCGCAACGAGCGCAACCCTTGATCTTAGTTGCCAGCATTCAGTTGGGCACTCTAA
GGTGACTGCCGGTGACAAACCGGAGGAAGGTGGGGATGACGTCAAATCATCATGCCCCTTATGACCTGGGCTACACA
CGTGCTACAATGGGCAGAACAAAGGGCAGCGAAACCGCGAGGTTAAGCCAATCCCACAAATCTGTTCTCAGTTCGGA
TCGCAGTCTGCAACTCGACTGCGTGAAGCTGGAATCGCTAGTAATCGCGGATCAGCATGCCGCGGTGAATACGTTCC
CGGGCCTTGTACACACCGCCCGTCACACCACGAGAGTTTGTAACACCCGAAGTCGGTGAGGTAACCTTTTTGGAGCC
AGCCGCCGAAGGTGGGACAGATGATTGGGGTGAAGTCGTAACAAGGTAGCCGTATCGGAAGGTGCGGCTGGATCACC
TCCTTT
The bacterial strain comprising a 16S rDNA sequence provided by SEQ ID NO: 3 (also
referred to herein as “Strain 3”) has the highest homology with a bacterial strain of the species
Bacillus licheniformis:
Strain 3 16S ribosomal RNA coding sequence (16S rDNA)
(SEQ ID NO: 3)
CACTTACAGATGGACCCGCGGCGCATTAGCTAGTTGGTGAGGTAACGGCTCACCAAGGCGACGATGCGTAGCCGACC
TGAGAGGGTGATCGGCCACACTGGGACTGAGACACGGCCCAGACTCCTACGGGAGGCAGCAGTAGGGAATCTTCCGC
AATGGACGAAAGTCTGACGGAGCAACGCCGCGTGAGTGATGAAGGTTTTCGGATCGTAAAACTCTGTTGTTAGGGAA
GAACAAGTACCGTTCGAATAGGGCGGTACCTTGACGGTACCTAACCAGAAAGCCACGGCTAACTACGTGCCAGCAGC
CGCGGTAATACGTAGGTGGCAAGCGTTGTCCGGAATTATTGGGCGTAAAGCGCGCGCAGGCGGTTTCTTAAGTCTGA
TGTGAAAGCCCCCGGCTCAACCGGGGAGGGTCATTGGAAACTGGGGAACTTGAGTGCAGAAGAGGAGAGTGGAATTC
CACGTGTAGCGGTGAAATGCGTAGAGATGTGGAGGAACACCAGTGGCGAAGGCGACTCTCTGGTCTGTAACTGACGC
TGAGGCGCGAAAGCGTGGGGAGCGAACAGGATTAGATACCCTGGTAGTCCACGCCGTAAACGATGAGTGCTAAGTGT
TAGAGGGTTTCCGCCCTTTAGTGCTGCAGCAAACGCATTAAGCACTCCGCCTGGGGAGTACGGTCGCAAGACTGAAA
CTCAAAGGAATTGACGGGGGCCCGCACAAGCGGTGGAGCATGTGGTTTAATTCGAAGCAACGCGAAGAACCTTACCA
GGTCTTGACATCCTCTGACAACCCTAGAGATAGGGCTTCCCCTTCGGGGGCAGAGTGACAGGTGGTGCATGGTTGTC
GTCAGCTCGTGTCGTGAGATGTTGGGTTAAGTCCCGCAACGAGCGCAACCCTTGATCTTAGTTGCCAGCATTCAGTT
GGGCACTCTAAGGTGACTGCCGGTGACAAACCGGAGGAAGGTGGGGATGACGTCAAATCATCATGCCCCTTATGACC
TGGGCTACACACGTGCTACAATGGGCAGAACAAAGGGCAGCGAAGCCGCGAGGCTAAGCCAATCCCACAAATCTGTT
CTCAGTTCGGATCGCAGTCTGCAACTCGACTGCGTGAAGCTGGAATCGCTAGTAATCGCGGATCAGCATGCCGCGGT
GAATACGTTCCCGGGCCTTGTACACACCGCCCGTCACACCACGAGAGTTTGTAACACCCGAAGTCGGTGAGGTAACC
TTTTGGAGCCAGCCGCCGAAGGTGGGACAGATGATTGGGGTGAAGTCGTAACAAGGTAGCCGTATCGGAAGGTGCGG
CTGGATCACCTCCTTT
The bacterial strain comprising a 16S rDNA sequence provided by SEQ ID NO: 4 (also
referred to herein as “Strain 4”) has the highest homology with a bacterial strain of the species
Bacillus pumilus:
Strain 4 16S ribosomal RNA coding sequence (16S rDNA)
(SEQ ID NO: 4)
ACGCTGGCGGCGTGCCTAATACATGCAAGTCGAGCGGACAGAAGGGAGCTTGCTCCCGGATGTTAGCGGCGGACGGG
TGAGTAACACGTGGGTAACCTGCCTGTAAGACTGGGATAACTCCGGGAAACCGGAGCTAATACCGGATAGTTCCTTG
AACCGCATGGTTCAAGGATGAAAGACGGTTTCGGCTGTCACTTACAGATGGACCCGCGGCGCATTAGCTAGTTGGTG
GGGTAATGGCTCACCAAGGCGACGATGCGTAGCCGACCTGAGAGGGTGATCGGCCACACTGGGACTGAGACACGGCC
CAGACTCCTACGGGAGGCAGCAGTAGGGAATCTTCCGCAATGGACGAAAGTCTGACGGAGCAACGCCGCGTGAGTGA
TGAAGGTTTTCGGATCGTAAAGCTCTGTTGTTAGGGAAGAACAAGTGCGAGAGTAACTGCTCGCACCTTGACGGTAC
CTAACCAGAAAGCCACGGCTAACTACGTGCCAGCAGCCGCGGTAATACGTAGGTGGCAAGCGTTGTCCGGAATTATT
GGGCGTAAAGGGCTCGCAGGCGGTTTCTTAAGTCTGATGTGAAAGCCCCCGGCTCAACCGGGGAGGGTCATTGGAAA
CTGGGAAACTTGAGTGCAGAAGAGGAGAGTGGAATTCCACGTGTAGCGGTGAAATGCGTAGAGATGTGGAGGAACAC
CAGTGGCGAAGGCGACTCTCTGGTCTGTAACTGACGCTGAGGAGCGAAAGCGTGGGGAGCGAACAGGATTAGATACC
CTGGTAGTCCACGCCGTAAACGATGAGTGCTAAGTGTTAGGGGGTTTCCGCCCCTTAGTGCTGCAGCTAACGCATTA
AGCACTCCGCCTGGGGAGTACGGTCGCAAGACTGAAACTCAAAGGAATTGACGGGGGCCCGCACAAGCGGTGGAGCA
TGTGGTTTAATTCGAAGCAACGCGAAGAACCTTACCAGGTCTTGACATCCTCTGACAACCCTAGAGATAGGGCTTTC
CCTTCGGGGACAGAGTGACAGGTGGTGCATGGTTGTCGTCAGCTCGTGTCGTGAGATGTTGGGTTAAGTCCCGCAAC
GAGCGCAACCCTTGATCTTAGTTGCCAGCATTTAGTTGGGCACTCTAAGGTGACTGCCGGTGACAAACCGGAGGAAG
GTGGGGATGACGTCAAATCATCATGCCCCTTATGACCTGGGCTACACACGTGCTACAATGGACAGAACAAAGGGCTG
CGAGACCGCAAGGTTTAGCCAATCCCATAAATCTGTTCTCAGTTCGGATCGCAGTCTGCAACTCGACTGCGTGAAGC
TGGAATCGCTAGTAATCGCGGATCAGCATGCCGCGGTGAATACGTTCCCGGGCCTTGTACACACCGCCCGTCACACC
ACGAGAGTTTGCAACACCCGAAGTCGGTGAGGTAACCTTTATGGAGCCAGCCGCCGAAGGTGGGGCAGATGATTGGG
GTGAAGTCGTAACAAGGTAGCCGTATCGGAAGGTGCGGCTGGATCACCTCCTTT
The bacterial strain comprising a 16S rDNA sequence provided by SEQ ID NO: 5 (also
referred to herein as “Strain 5”) has the highest homology with a bacterial strain of the species
Pediococcus pentosaceus:
Strain 5 16S ribosomal RNA coding sequence (16S rDNA)
(SEQ ID NO: 5)
ATGAGAGTTTGATCTTGGCTCAGGATGAACGCTGGCGGCGTGCCTAATACATGCAAGTCGAACGAACTTCCGTTAAT
TGATTATGACGTACTTGTACTGATTGAGATTTTAACACGAAGTGAGTGGCGAACGGGTGAGTAACACGTGGGTAACC
TGCCCAGAAGTAGGGGATAACACCTGGAAACAGATGCTAATACCGTATAACAGAGAAAACCGCATGGTTTTCTTTTA
AAAGATGGCTCTGCTATCACTTCTGGATGGACCCGCGGCGTATTAGCTAGTTGGTGAGGTAAAGGCTCACCAAGGCA
GTGATACGTAGCCGACCTGAGAGGGTAATCGGCCACATTGGGACTGAGACACGGCCCAGACTCCTACGGGAGGCAGC
AGTAGGGAATCTTCCACAATGGACGCAAGTCTGATGGAGCAACGCCGCGTGAGTGAAGAAGGGTTTCGGCTCGTAAA
GCTCTGTTGTTAAAGAAGAACGTGGGTAAGAGTAACTGTTTACCCAGTGACGGTATTTAACCAGAAAGCCACGGCTA
ACTACGTGCCAGCAGCCGCGGTAATACGTAGGTGGCAAGCGTTATCCGGATTTATTGGGCGTAAAGCGAGCGCAGGC
GGTCTTTTAAGTCTAATGTGAAAGCCTTCGGCTCAACCGAAGAAGTGCATTGGAAACTGGGAGACTTGAGTGCAGAA
GAGGACAGTGGAACTCCATGTGTAGCGGTGAAATGCGTAGATATATGGAAGAACACCAGTGGCGAAGGCGGCTGTCT
GGTCTGCAACTGACGCTGAGGCTCGAAAGCATGGGTAGCGAACAGGATTAGATACCCTGGTAGTCCATGCCGTAAAC
GATGATTACTAAGTGTTGGAGGGTTTCCGCCCTTCAGTGCTGCAGCTAACGCATTAAGTAATCCGCCTGGGGAGTAC
GACCGCAAGGTTGAAACTCAAAAGAATTGACGGGGGCCCGCACAAGCGGTGGAGCATGTGGTTTAATTCGAAGCTAC
GCGAAGAACCTTACCAGGTCTTGACATCTTCTGACAGTCTAAGAGATTAGAGGTTCCCTTCGGGGACAGAATGACAG
GTGGTGCATGGTTGTCGTCAGCTCGTGTCGTGAGATGTTGGGTTAAGTCCCGCAACGAGCGCAACCCTTATTACTAG
TTGCCAGCATTAAGTTGGGCACTCTAGTGAGACTGCCGGTGACAAACCGGAGGAAGGTGGGGACGACGTCAAATCAT
CATGCCCCTTATGACCTGGGCTACACACGTGCTACAATGGATGGTACAACGAGTCGCGAGACCGCGAGGTTAAGCTA
ATCTCTTAAAACCATTCTCAGTTCGGACTGTAGGCTGCAACTCGCCTACACGAAGTCGGAATCGCTAGTAATCGCGG
ATCAGCATGCCGCGGTGAATACGTTCCCGGGCCTTGTACACACCGCCCGTCACACCATGAGAGTTTGTAACACCCAA
AGCCGGTGGGGTAACCTTTTAGGAGCTAGCCGTCTAAGGTGGGACAGATGATTAGGGTGAAGTCGTAACAAGGTAGC
CGTAGGAGAACCTGCGGCTGGATCACCTCCTT
The bacterial strain comprising a 16S rDNA sequence provided by SEQ ID NO: 6 (also
referred to herein as “Strain 6”) has the highest homology with a bacterial strain of the species
Lactiplantibacillus plantarum:
Strain 6 16S ribosomal RNA coding sequence (16S rDNA)
(SEQ ID NO: 6)
CTATCACTTTTGGATGGTCCCGCGGCGTATTAGCTAGATGGTGGGGTAACGGCTCACCATGGCAATGATACGTAGCC
GACCTGAGAGGGTAATCGGCCACATTGGGACTGAGACACGGCCCAAACTCCTACGGGAGGCAGCAGTAGGGAATCTT
CCACAATGGACGAAAGTCTGATGGAGCAACGCCGCGTGAGTGAAGAAGGGTTTCGGCTCGTAAAACTCTGTTGTTAA
AGAAGAACATATCTGAGAGTAACTGTTCAGGTATTGACGGTATTTAACCAGAAAGCCACGGCTAACTACGTGCCAGC
AGCCGCGGTAATACGTAGGTGGCAAGCGTTGTCCGGATTTATTGGGCGTAAAGCGAGCGCAGGCGGTTTTTTAAGTC
TGATGTGAAAGCCTTCGGCTCAACCGAAGAAGTGCATCGGAAACTGGGAAACTTGAGTGCAGAAGAGGACAGTGGAA
CTCCATGTGTAGCGGTGAAATGCGTAGATATATGGAAGAACACCAGTGGCGAAGGCGGCTGTCTGGTCTGTAACTGA
CGCTGAGGCTCGAAAGTATGGGTAGCAAACAGGATTAGATACCCTGGTAGTCCATACCGTAAACGATGAATGCTAAG
TGTTGGAGGGTTTCCGCCCTTCAGTGCTGCAGCTAACGCATTAAGCATTCCGCCTGGGGAGTACGGCCGCAAGGCTG
AAACTCAAAGGAATTGACGGGGGCCCGCACAAGCGGTGGAGCATGTGGTTTAATTCGAAGCTACGCGAAGAACCTTA
CCAGGTCTTGACATACTATGCAAATCTAAGAGATTAGACGTTCCCTTCGGGGACATGGATACAGGTGGTGCATGGTT
GTCGTCAGCTCGTGTCGTGAGATGTTGGGTTAAGTCCCGCAACGAGCGCAACCCTTATTATCAGTTGCCAGCATTAA
GTTGGGCACTCTGGTGAGACTGCCGGTGACAAACCGGAGGAAGGTGGGGATGACGTCAAATCATCATGCCCCTTATG
ACCTGGGCTACACACGTGCTACAATGGATGGTACAACGAGTTGCGAACTCGCGAGAGTAAGCTAATCTCTTAAAGCC
ATTCTCAGTTCGGATTGTAGGCTGCAACTCGCCTACATGAAGTCGGAATCGCTAGTAATCGCGGATCAGCATGCCGC
GGTGAATACGTTCCCGGGCCTTGTACACACCGCCCGTCACACCATGAGAGTTTGTAACACCCAAAGTCGGTGGGGTA
ACCTTTTAGGAACCAGCCGCCTAAGGTGGGACAGATGATTAGGGTGAAGTCGTAACAAGGTAGCCGTAGGAGAACCT
GCGGCTGGATCACCTCCTT
The bacterial strain comprising a 16S rDNA sequence provided by SEQ ID NO: 7 (also
referred to herein as “Strain 7”) has the highest homology with a bacterial strain of the species
Lactobacillus delbrueckii:
Strain 7 16S ribosomal RNA coding sequence (16S rDNA)
(SEQ ID NO: 7)
AGAGTTTGATCCTGGCTCAGGACGAACGCTGGCGGCGTGCCTAATACATGCAAGTCGAGCGAGCTGAATTCAAAGAT
CCCTTCGGGGTGATTTGTTGGACGCTAGCGGCGGATGGGTGAGTAACACGTGGGCAATCTGCCCTAAAGACTGGGAT
ACCACTTGGAAACAGGTGCTAATACCGGATAACAACATGAATCGCATGATTCAAGTTTGAAAGGCGGCGCAAGCTGT
CACTTTAGGATGAGCCCGCGGCGCATTAGCTAGTTGGTGGGGTAAAGGCCTACCAAGGCAATGATGCGTAGCCGAGT
TGAGAGACTGATCGGCCACATTGGGACTGAGACACGGCCCAAACTCCTACGGGAGGCAGCAGTAGGGAATCTTCCAC
AATGGACGCAAGTCTGATGGAGCAACGCCGCGTGAGTGAAGAAGGTCTTCGGATCGTAAAGCTCTGTTGTTGGTGAA
GAAGGATAGAGGCAGTAACTGGTCTTTATTTGACGGTAATCAACCAGAAAGTCACGGCTAACTACGTGCCAGCAGCC
GCGGTAATACGTAGGTGGCAAGCGTTGTCCGGATTTATTGGGCGTAAAGCGAGCGCAGGCGGAATGATAAGTCTGAT
GTGAAAGCCCACGGCTCAACCGTGGAACTGCATCGGAAACTGTCATTCTTGAGTGCAGAAGAGGAGAGTGGAACTCC
ATGTGTAGCGGTGGAATGCGTAGATATATGGAAGAACACCAGTGGCGAAGGCGGCTCTCTGGTCTGCAACTGACGCT
GAGGCTCGAAAGCATGGGTAGCGAACAGGATTAGATACCCTGGTAGTCCATGCCGTAAACGATGAGCGCTAGGTGTT
GGGGACTTTCCNGTCCTCAGTGCCGCAGCAAACGCATTAAGCGCTCCGCCTGGGGAGTACGACCGCAAGGTTGAAAC
TCAAAGGAATTGACGGGGGCCCGCACAAGCGGTGGAGCATGTGGTTTAATTCGAAGCAACGCGAAGAACCTTACCAG
GTCTTGACATCCTGCGCTACACCTAGAGATAGGTGGTTCCCTTCGGGGACGCAGAGACAGGTGGTGCATGGCTGTCG
TCAGCTCGTGTCGTGAGATGTTGGGTTAAGTCCCGCAACGAGCGCAACCCTTGTCTTTAGTTGCCATCATTAAGTTG
GGCACTCTAAAGAGACTGCCGGTGACAAACCGGAGGAAGGTGGGGATGACGTCAAGTCATCATGCCCCTTATGACCT
GGGCTACACACGTGCTACAATGGGCAGTACAACGAGAAGCNAACCCGCGAGGGTAAGCGGATCTCTTAAAGCTGTTC
TCAGTTCGGACTGCAGGCTGCAACTCGCCTGCACGAAGCTGGAATCGCTAGTAATCGCGGATCAGCACGCCGCGGTG
AATACGTTCCCGGGCCTTGTACACACCGCCCGTCACACCATGGAAGTCTGCAATGCCCAAAGTCGGTGAGATAACCT
TTATAGGAGTCAGCCGCCTAAGGCAGGGCAGATGACTGGGGTGAAGTCGTAACAAGGTAACC
The bacterial strain comprising a 16S rDNA sequence provided by SEQ ID NO: 8 (also
referred to herein as “Strain 8”) has the highest homology with a bacterial strain of the species
Limosilactobacillus fermentum:
Strain 8 16S ribosomal RNA coding sequence (16S rDNA)
(SEQ ID NO: 8)
TATGAGAGTTTGATCCTGGCTCAGGATGAACGCCGGCGGTGTGCCTAATACATGCAAGTCGAACGCGTTGGCCCAAT
TGATTGATGGTGCTTGCACCTGATTGATTTTGGTCGCCAACGAGTGGCGGACGGGTGAGTAACACGTAGGTAACCTG
CCCAGAAGCGGGGGACAACATTTGGAAACAGATGCTAATACCGCATAACAACGTTGTTCGCATGAACAACGCTTAAA
AGATGGCTTCTCGCTATCACTTCTGGATGGACCTGCGGTGCATTAGCTTGTTGGTGGGGTAATGGCCTACCAAGGCG
ATGATGCATAGCCGAGTTGAGAGACTGATCGGCCACAATGGGACTGAGACACGGCCCATACTCCTACGGGAGGCAGC
AGTAGGGAATCTTCCACAATGGGCGCAAGCCTGATGGAGCAACACCGCGTGAGTGAAGAAGGGTTTCGGCTCGTAAA
GCTCTGTTGTTAAAGAAGAACACGTATGAGAGTAACTGTTCATACGTTGACGGTATTTAACCAGAAAGTCACGGCTA
ACTACGTGCCAGCAGCCGCGGTAATACGTAGGTGGCAAGCGTTATCCGGATTTATTGGGCGTAAAGAGAGTGCAGGC
GGTTTTCTAAGTCTGATGTGAAAGCCTTCGGCTTAACCGGAGAAGTGCATCGGAAACTGGATAACTTGAGTGCAGAA
GAGGGTAGTGGAACTCCATGTGTAGCGGTGGAATGCGTAGATATATGGAAGAACACCAGTGGCGAAGGCGGCTACCT
GGTCTGCAACTGACGCTGAGACTCGAAAGCATGGGTAGCGAACAGGATTAGATACCCTGGTAGTCCATGCCGTAAAC
GATGAGTGCTAGGTGTTGGAGGGTTTCCGCCCTTCAGTGCCGGAGCTAACGCATTAAGCACTCCGCCTGGGGAGTAC
GACCGCAAGGTTGAAACTCAAAGGAATTGACGGGGGCCCGCACAAGCGGTGGAGCATGTGGTTTAATTCGAAGCTAC
GCGAAGAACCTTACCAGGTCTTGACATCTTGCGCCAACCCTAGAGATAGGGCGTTTCCTTCGGGAACGCAATGACAG
GTGGTGCATGGTCGTCGTCAGCTCGTGTCGTGAGATGTTGGGTTAAGTCCCGCAACGAGCGCAACCCTTGTTACTAG
TTGCCAGCATTAAGTTGGGCACTCTAGTGAGACTGCCGGTGACAAACCGGAGGAAGGTGGGGACGACGTCAGATCAT
CATGCCCCTTATGACCTGGGCTACACACGTGCTACAATGGACGGTACAACGAGTCGCGAACTCGCGAGGGCAAGCAA
ATCTCTTAAAACCGTTCTCAGTTCGGACTGCAGGCTGCAACTCGCCTGCACGAAGTCGGAATCGCTAGTAATCGCGG
ATCAGCATGCCGCGGTGAATACGTTCCCGGGCCTTGTACACACCGCCCGTCACACCATGAGAGTTTGTAACACCCAA
AGTCGGTGGGGTAACCTTTTAGGAGCCAGCCGCCTAAGGTGGGACAGATGATTAGGGTGAAGTCGTAACAAGGTAGC
CGTAGGAGAACCTGCGGCTGGATCACCTCCTT
The bacterial strain comprising a 16S rDNA sequence provided by SEQ ID NO: 9 (also
referred to herein as “Strain 9”) has the highest homology with a bacterial strain of the species
Bacillus subtilis:
Strain 9 16S ribosomal RNA coding sequence (16S rDNA)
(SEQ ID NO: 9)
GTTAGCGGCGGACGGGTGAGTAACACGTGGGTAACCTGCCTGTAAGACTGGGATAACTCCGGGAAACCGGGGCTAAT
ACCGGATGGTTGTTTGAACCGCATGGTTCAAACATAAAAGGTGGCTTCGGCTACCACTTACAGATGGACCCGCGGCG
CATTAGCTAGTTGGTGAGGTAACGGCTCACCAAGGCGACGATGCGTAGCCGACCTGAGAGGGTGATCGGCCACACTG
GGACTGAGACACGGCCCAGACTCCTACGGGAGGCAGCAGTAGGGAATCTTCCGCAATGGACGAAAGTCTGACGGAGC
AACGCCGCGTGAGTGATGAAGGTTTTCGGATCGTAAAGCTCTGTTGTTAGGGAAGAACAAGTACCGTTCGAATAGGG
CGGTACCTTGACGGTACCTAACCAGAAAGCCACGGCTAACTACGTGCCAGCAGCCGCGGTAATACGTAGGTGGCAAG
CGTTGTCCGGAATTATTGGGCGTAAAGGGCTCGCAGGCGGTTTCTTAAGTCTGATGTGAAAGCCCCCGGCTCAACCG
GGGAGGGTCATTGGAAACTGGGGAACTTGAGTGCAGAAGAGGAGAGTGGAATTCCACGTGTAGCGGTGAAATGCGTA
GAGATGTGGAGGAACACCAGTGGCGAAGGCGACTCTCTGGTCTGTAACTGACGCTGAGGAGCGAAAGCGTGGGGAGC
GAACAGGATTAGATACCCTGGTAGTCCACGCCGTAAACGATGAGTGCTAAGTGTTAGGGGGTTTCCGCCCCTTAGTG
CTGCAGCTAACGCATTAAGCACTCCGCCTGGGGAGTACGGTCGCAAGACTGAAACTCAAAGGAATTGACGGGGGCCC
GCACAAGCGGTGGAGCATGTGGTTTAATTCGAAGCAACGCGAAGAACCTTACCAGGTCTTGACATCCTCTGACAATC
CTAGAGATAGGACGTCCCCTTCGGGGGCAGAGTGACAGGTGGTGCATGGTTGTCGTCAGCTCGTGTCGTGAGATGTT
GGGTTAAGTCCCGCAACGAGCGCAACCCTTGATCTTAGTTGCCAGCATTCAGTTGGGCACTCTAAGGTGACTGCCGG
TGACAAACCGGAGGAAGGTGGGGATGACGTCAAATCATCATGCCCCTTATGACCTGGGCTACACACGTGCTACAATG
GACAGAACAAAGGGCAGCGAAACCGCGAGGTTAAGCCAATCCCACAAATCTGTTCTCAGTTCGGATCGCAGTCTGCA
ACTCGACTGCGTGAAGCTGGAATCGCTAGTAATCGCGGATCAGCATGCCGCGGTGAATACGTTCCCGGGCCTTGTAC
ACACCGCCCGTCACACCACGAGAGTTTGTAACACCCGAAGTCGGTGAGGTAACCTTTTAGGAGCCAGCCGCCGAAGG
TGGGACAGATGATTGGGGTGAAGTCGTAACAAGGTAGCCGTATCGGAAGGTGCGGCTGGATCACCTCCTTT

In some embodiments, a composition comprises fermentates of two or more bacterial strains belonging to the species Bacillus subtilis, wherein the bacterial strains belonging to the species Bacillus subtilis are different bacterial strains. In some embodiments, the bacterial mixture comprises one bacterial strain belonging to Bacillus subtilis. In some embodiments, the bacterial mixture comprises two bacterial strains belonging to Bacillus subtilis. In some embodiments, the bacterial mixture comprises 2, 3, 4, 5, 6, 7, 8, 9, or 10 bacterial strains belonging to Bacillus subtilis. In some embodiments, a first bacterial strain belonging to Bacillus subtilis comprises a 16S rDNA sequence with at least 97% sequence identity to the nucleic acid sequence of SEQ ID NO: 1, and a second bacterial strain belonging to Bacillus subtilis comprises a 16S rDNA sequence with at least 97% sequence identity to the nucleic acid sequence of SEQ ID NO: 9, and the 16S rDNA sequences of the first and second bacterial strains belonging to Bacillus subtilis are not 100% identical. In some embodiments, the 16S rDNA sequence of the first bacterial strain belonging to Bacillus subtilis has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Bacillus subtilis.

In some embodiments, a composition comprises fermentates of two or more bacterial strains belonging to the species Bacillus amyloliquefaciens, wherein the bacterial strains belonging to the species Bacillus amyloliquefaciens are different bacterial strains. In some embodiments, the bacterial mixture comprises one bacterial strain belonging to Bacillus amyloliquefaciens. In some embodiments, the bacterial mixture comprises two bacterial strains belonging to Bacillus amyloliquefaciens. In some embodiments, the bacterial mixture comprises 2, 3, 4, 5, 6, 7, 8, 9, or 10 bacterial strains belonging to Bacillus amyloliquefaciens. In some embodiments, the 16S rDNA sequence of the first bacterial strain belonging to Bacillus amyloliquefaciens has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Bacillus amyloliquefaciens.

In some embodiments, a composition comprises fermentates of two or more bacterial strains belonging to the species Bacillus licheniformis, wherein the bacterial strains belonging to the species Bacillus licheniformis are different bacterial strains. In some embodiments, the bacterial mixture comprises a fermentate from one bacterial strain belonging to Bacillus licheniformis. In some embodiments, the bacterial mixture comprises fermentates from two bacterial strains belonging to Bacillus licheniformis. In some embodiments, the composition comprises fermentates from 2, 3, 4, 5, 6, 7, 8, 9, or 10 bacterial strains belonging to Bacillus licheniformis. In some embodiments, the 16S rDNA sequence of the first bacterial strain belonging to Bacillus licheniformis has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Bacillus licheniformis.

In some embodiments, a composition comprises fermentates of two or more bacterial strains belonging to the species Bacillus pumilus, wherein the bacterial strains belonging to the species Bacillus pumilus are different bacterial strains. In some embodiments, the composition comprises a fermentate from one bacterial strain belonging to Bacillus pumilus. In some embodiments, the bacterial mixture comprises fermentates from two bacterial strains belonging to Bacillus pumilus. In some embodiments, the composition comprises fermentates from 2, 3, 4, 5, 6, 7, 8, 9, or 10 bacterial strains belonging to Bacillus pumilus. In some embodiments, the 16S rDNA sequence of the first bacterial strain belonging to Bacillus pumilus has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Bacillus pumilus.

In some embodiments, a composition comprises fermentates of two or more bacterial strains belonging to the species Pediococcus pentosaceus, wherein the bacterial strains belonging to the species Pediococcus pentosaceus are different bacterial strains. In some embodiments, the composition comprises a fermentate from one bacterial strain belonging to Pediococcus pentosaceus. In some embodiments, the composition comprises fermentates from two bacterial strains belonging to Pediococcus pentosaceus. In some embodiments, the composition comprises fermentates from 2, 3, 4, 5, 6, 7, 8, 9, or 10 bacterial strains belonging to Pediococcus pentosaceus. In some embodiments, the 16S rDNA sequence of the first bacterial strain belonging to Pediococcus pentosaceus has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Pediococcus pentosaceus.

In some embodiments, a composition comprises fermentates of two or more bacterial strains belonging to the species Lactiplantibacillus plantarum, wherein the bacterial strains belonging to the species Lactiplantibacillus plantarum are different bacterial strains. In some embodiments, the composition comprises a fermentate from one bacterial strain belonging to Lactiplantibacillus plantarum. In some embodiments, the composition comprises fermentates from two bacterial strains belonging to Lactiplantibacillus plantarum. In some embodiments, the composition comprises fermentates from 2, 3, 4, 5, 6, 7, 8, 9, or 10 bacterial strains belonging to Lactiplantibacillus plantarum. In some embodiments, the 16S rDNA sequence of the first bacterial strain belonging to Lactiplantibacillus plantarum has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Lactiplantibacillus plantarum.

In some embodiments, a composition comprises fermentates of two or more bacterial strains belonging to the species Lactobacillus delbrueckii, wherein the bacterial strains belonging to the species Lactobacillus delbrueckii are different bacterial strains. In some embodiments, the composition comprises a fermentate from one bacterial strain belonging to Lactobacillus delbrueckii. In some embodiments, the composition comprises fermentates from two bacterial strains belonging to Lactobacillus delbrueckii. In some embodiments, the composition comprises fermentates from 2, 3, 4, 5, 6, 7, 8, 9, or 10 bacterial strains belonging to Lactobacillus delbrueckii. In some embodiments, the 16S rDNA sequence of the first bacterial strain belonging to Lactobacillus delbrueckii has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Lactobacillus delbrueckii.

In some embodiments, a composition comprises fermentates of two or more bacterial strains belonging to the species Limosilactobacillus fermentum, wherein the bacterial strains belonging to the species Limosilactobacillus fermentum are different bacterial strains. In some embodiments, the composition comprises a fermentate from one bacterial strain belonging to Limosilactobacillus fermentum. In some embodiments, the composition comprises fermentates from two bacterial strains belonging to Limosilactobacillus fermentum. In some embodiments, the composition comprises fermentates from 2, 3, 4, 5, 6, 7, 8, 9, or 10 bacterial strains belonging to Limosilactobacillus fermentum. In some embodiments, the 16S rDNA sequence of the first bacterial strain belonging to Limosilactobacillus fermentum has no more than 99.9%, 99.8%, 99.7%, 99.6%, 99.5%, 99.4%, 99.3%, 99.2%, 99.1%, 99.0%, 98.8%, 98.6%, 98.5%, 98.4%, 98.2%, 98.0%, 97.8%, 97.6%, 97.5%, 97.4%, or 97.2% identity to 16S rDNA sequence of the second bacterial strain belonging to Limosilactobacillus fermentum.

In some embodiments, a composition comprises a fermentate of one or more additional bacterial strains. Additional bacterial strains that produce fermentates may be taxonomically or phylogenetically related to bacterial strains of Bacillus subtilis, Bacillus amyloliquefaciens, Bacillus licheniformis, Bacillus pumilus, Pediococcus pentosaceus, Lactiplantibacillus plantarum, Lactobacillus delbrueckii, and Limosilactobacillus fermentum. In some embodiments, one or more additional bacterial strains belong to the species Bacillus subtilis. In some embodiments, one or more additional bacterial strains belong to the species Bacillus amyloliquefaciens. In some embodiments, one or more additional bacterial strains belong to the species Bacillus licheniformis. In some embodiments, one or more additional bacterial strains belong to the species Bacillus pumilus. In some embodiments, one or more additional bacterial strains belong to the species Pediococcus pentosaceus. In some embodiments, one or more additional bacterial strains belong to the species Lactiplantibacillus plantarum. In some embodiments, one or more additional bacterial strains belong to the species Lactobacillus delbrueckii. In some embodiments, one or more additional bacterial strains belong to the species Limosilactobacillus fermentum.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Bacillus subtilis. In some embodiments, the 16S rDNA sequence of an additional bacterial strain belonging to Bacillus subtilis is not identical to SEQ ID NO: 1 or SEQ ID NO: 9. In some embodiments, an additional bacterial strain belonging to Bacillus subtilis comprises a 16S rDNA sequence that has at least 97%, but less than 100%, sequence identity to the nucleic acid sequence of SEQ ID NO: 1, and less than 100% sequence identity to the nucleic acid sequence of SEQ ID NO: 9.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Bacillus amyloliquefaciens. In some embodiments, the 16S rDNA sequence of an additional bacterial strain belonging to Bacillus amyloliquefaciens is not identical to SEQ ID NO: 2. In some embodiments, an additional bacterial strain belonging to Bacillus amyloliquefaciens comprises a 16S rDNA sequence that has at least 97%, but less than 100%, sequence identity to the nucleic acid sequence of SEQ ID NO: 2.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Bacillus licheniformis. In some embodiments, the 16S rDNA sequence of an additional bacterial strain belonging to Bacillus licheniformis is not identical to SEQ ID NO: 3. In some embodiments, an additional bacterial strain belonging to Bacillus licheniformis comprises a 16S rDNA sequence that has at least 97%, but less than 100%, sequence identity to the nucleic acid sequence of SEQ ID NO: 3.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Bacillus pumilus. In some embodiments, the 16S rDNA sequence of an additional bacterial strain belonging to Bacillus pumilus is not identical to SEQ ID NO: 4. In some embodiments, an additional bacterial strain belonging to Bacillus pumilus comprises a 16S rDNA sequence that has at least 97%, but less than 100%, sequence identity to the nucleic acid sequence of SEQ ID NO: 4.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Pediococcus pentosaceus. In some embodiments, the 16S rDNA sequence of an additional bacterial strain belonging to Pediococcus pentosaceus is not identical to SEQ ID NO: 5. In some embodiments, an additional bacterial strain belonging to Pediococcus pentosaceus comprises a 16S rDNA sequence that has at least 97%, but less than 100%, sequence identity to the nucleic acid sequence of SEQ ID NO: 5.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Lactiplantibacillus plantarum. In some embodiments, the 16S rDNA sequence of an additional bacterial strain belonging to Lactiplantibacillus plantarum is not identical to SEQ ID NO: 6. In some embodiments, an additional bacterial strain belonging to Lactiplantibacillus plantarum comprises a 16S rDNA sequence that has at least 97%, but less than 100%, sequence identity to the nucleic acid sequence of SEQ ID NO: 6.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Lactobacillus delbrueckii. In some embodiments, the 16S rDNA sequence of an additional bacterial strain belonging to Lactobacillus delbrueckii is not identical to SEQ ID NO: 7. In some embodiments, an additional bacterial strain belonging to Lactobacillus delbrueckii comprises a 16S rDNA sequence that has at least 97%, but less than 100%, sequence identity to the nucleic acid sequence of SEQ ID NO: 7.

In some embodiments, a composition comprises fermentates of 2, 3, 4, 5, 6, 7, 8, 9, 10, 11, 12, 13, 14, 15, 16, 17, 18, 19, or 20 additional bacterial strains belonging to the species Limosilactobacillus fermentum. In some embodiments, the 16S rDNA sequence of an additional bacterial strain belonging to Limosilactobacillus fermentum is not identical to SEQ ID NO: 8. In some embodiments, an additional bacterial strain belonging to Limosilactobacillus fermentum comprises a 16S rDNA sequence that has at least 97%, but less than 100%, sequence identity to the nucleic acid sequence of SEQ ID NO: 8.

Some embodiments of the compositions described herein comprise fermentates of two or more bacterial strains. In some embodiments, the composition comprises fermentates of at least 2, at least 3 at least 4, at least 5, at least 6, at least 7, at least 8, at least 9, at least 10, at least 11, at least 12, at least 13, at least 14, at least 15, at least 16, at least 17, at least 18, at least 19, or up to 20 total bacterial strains. In some embodiments, the composition comprises fermentates of 2-20, 2-19, 2-18, 2-17, 2-16, 2-15, 2-14, 2-13, 2-12, 2-11, 2-10, 2-9, 2-8, 2-7, 2-6, 2-5, 2-4, 2-3, 3-20, 3-19, 3-18, 3-17, 3-16, 3-15, 3-14, 3-13, 3-12, 3-11, 3-10, 3-9, 3-8, 3-7, 3-6, 3-5, 3-4, 4-20, 4-19, 4-18, 4-17, 4-16, 4-15, 4-14, 4-13, 4-12, 4-11, 4-10, 4-9, 4-8, 4-7, 4-6, 4-5, 5-20, 5-19, 5-18, 5-17, 5-16, 5-15, 5-14, 5-13, 5-12, 5-11, 5-10, 5-9, 5-8, 5-7, 5-6, 6-20, 6-19, 6-18, 6-17, 6-16, 6-15, 6-14, 6-13, 6-12, 6-11, 6-10, 6-9, 6-8, 6-7, 7-20, 7-19, 7-18, 7-17, 7-16, 7-15, 7-14, 7-13, 7-12, 7-11, 7-10, 7-9, 7-8, 8-20, 8-19, 8-18, 8-17, 8-16, 8-15, 8-14, 8-13, 8-12, 8-11, 8-10, 8-9, 9-20, 9-19, 9-18, 9-17, 9-16, 9-15, 9-14, 9-13, 9-12, 9-11, 9-10, 10-20, 10-19, 10-18, 10-17, 10-16, 10-15, 10-14, 10-13, 10-12, 10-11, 11-20, 11-19, 11-18, 11-17, 11-16, 11-15, 11-14, 11-13, 11-12, 12-20, 12-19, 12-18, 12-17, 12-16, 12-15, 12-14, 12-13, 13-20, 13-19, 13-18, 13-17, 13-16, 13-15, 13-14, 14-20, 14-19, 14-18, 14-17, 14-16, 14-15, 15-20, 15-19, 15-18, 15-17, 15-16, 16-20, 16-19, 16-18, 16-17, 17-20, 17-19, 17-18, 18-20, 18-19, or 19-20.

It will be appreciated that the terms “bacterial strains,” “microbial strains” “microbes,” “bacterial cells” and “microorganisms” are used interchangeably herein.

Bacterial strains identified as described herein were compared with sequences in publicly available nucleic acid databases, such as Basic Local Alignment Search Tool (BLAST) to determine closely related genera and species and were analyzed using taxonomic assignment tools, such as RDP Classifier, which assign bacterial taxonomy to representative sequences.

16S ribosomal DNA (16S rDNA) sequences encoding 16S ribosomal RNA (16S rRNA) are provided below for representative bacterial strains. The closest related identified bacterial species were determined based on whole genome sequence analysis and a combination of analysis of full length 16S rDNA sequences and the sequences of single-copy conserved genes compared to publicly available sequence databases. It should be appreciated that multiple bacterial strains disclosed herein may have the highest homology with the same species. In some embodiments, bacterial strains having the same or highly related 16S rDNA variable region sequences are phenotypically distinct. For example, two strains may differ phenotypically by growth rate, antibiotic resistance, phage resistance, cell wall thickness, motility, competence, spore-forming ability, rates of metabolite (e.g., VSC) degradation, ability to degrade a given metabolite, and/or ability to inhibit production of a given molecule. It should further be appreciated that the bacterial strains disclosed herein that have a 16S rDNA sequence with a nucleic acid sequence selected from the group consisting of SEQ ID NOs: 1-9, are also homologous to other strains based on their whole genome sequence, or subset of their whole genome sequence.

It should further be appreciated that the bacterial species described herein may be identified based on the nucleotide sequence of the full length 16S rDNA. Alternatively or in addition, the bacterial species described herein may be identified based on identification of 16S sequences through whole genome sequencing, and by comparing the sequences with 16S databases, or comparing the whole genome sequence, or a subset of their whole genome sequence to sequence databases.

It should be appreciated that the compositions (and/or nutritional supplements and/or dental supplements and/or food products comprising the same) may include fermentates of multiple strains of a particular species. In some embodiments, the composition includes multiple strains of a particular species that are obtained from independent sources, but the strains have the same or highly related 16S rDNA sequences.

Some embodiments relate to bacterial strains with 16S rDNA sequences that have sequence identity to a nucleic acid sequence of any one of the sequences of the bacterial strains or bacterial species described herein. In some embodiments, the bacterial strain has at least 60%, at least 70%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or up to 100% sequence identity relative to any of the bacterial strains or bacterial species described herein over a specified region (such as a region of the 16S rDNA sequences provided herein) or over the entire sequence (such as the entire 16S rDNA).

“Identity” refers to the degree of sequence relatedness between or among sequences as determined by the number of matching positions between strings of two or more nucleotide sequences. “Percent (%) identity” or “percent (%) sequence identity” as it applies to nucleotide sequences is defined as the percentage of nucleotides in the candidate nucleotide sequence that are identical to the nucleotide sequence of a reference sequence after aligning the sequences and introducing gaps, as necessary, to achieve the maximum score allowed by the alignment algorithm and parameters.

Where an alignment between two sequences is contemplated, the first sequence (e.g., candidate sequence) is aligned to the second sequence (e.g., reference sequence) using the Needleman-Wunsch algorithm for global alignment of the two sequences. Needleman & Wunsch, J Mol Biol. 1970. 48:443-453. Where two nucleotide sequences are aligned, the alignment uses an EDNAFULL substitution scoring matrix, a Gap Open penalty of 10, a Gap Extend penalty of 0.5, and no End Gap penalties. The skilled artisan will appreciate that at the time of filing the instant specification, these parameters are the default parameters of the EMBOSS Needle pairwise comparison tool provided by European Bioinformatics Institute (see ebi.ac.uk). Other suitable alignment programs may be used to obtain a global alignment using these parameters, such as BLAST, or the Needleman-Wunsch algorithm may be implemented in a scripting language (e.g., Python).

The percent sequence identity that a candidate sequence (e.g., as present in a bacterial strain encompassed by a claim) has to a reference sequence (e.g., having a SEQ ID NO: specified herein and recited in a claim) is calculated by (i) aligning the candidate sequence to the reference sequence, (ii) determining the number of matching nucleotides between the aligned candidate and reference sequences, and (iii) dividing the number of matching nucleotides by the length of the reference sequence, including any internal gaps introduced into the reference sequence when the two sequences are aligned.

The skilled artisan will appreciate that to determine whether a candidate nucleotide sequence comprises a nucleotide sequence with a given percentage sequence identity to a reference sequence, the denominator (length of reference sequence plus internal gaps) in calculating percent identity need not include gaps shown extending past the ends of the reference sequence in an alignment. Such gaps are added where a candidate sequence contains additional nucleotides that extend beyond the portions of the candidate sequence that align to the 5′ end or 3′ end of the reference sequence.

As will be appreciated by one of ordinary skill in the art, nomenclature regarding bacterial genus and species names may be reclassified to reflect phylogenetic relationships of microorganisms. See, e.g., Zheng et al., Inter. J. System. And Evol. Microbiol. (2020) 70 (4).

Bacterial strains may be obtained from or derived from any suitable source, such as from a food source or an environmental source. As used herein, the term “derived from” in the context of bacterial strains derived from a particular source refers to obtaining a bacterial strain from the source, which may involve isolating and/or propagating cells of a bacterial strain. In some embodiments, the bacterial strains are further manipulated, such as purified and/or analyzed, prior to use. As will be evident to one of ordinary skill in the art, reference to a bacterial strain or cells of a bacterial strain that is derived from a particular source encompasses progeny cells thereof.

Bacterial strains may be derived from a fermented food or beverage, such as cultured milk and yogurt, natto, cheese, kombucha, wine, beer, cider, miso, kimchi, sauerkraut, fermented sausage, among others. Additionally, bacterial strains may be derived from cultured plants or plant protein isolates, including plants or proteins isolated from cereal grains (e.g., oats), oil seeds (e.g., sunflower seeds), legumes, pulses, beans, broad beans, faba beans, peas, chickpeas, cow peas, pigeon peas, lentils, Bambara beans, vetches, and lupins.

In some embodiments, at least one bacterial strain may be purified. In some embodiments, at least one bacterial strain may be isolated. Any of the bacterial strains described herein may be isolated and/or purified, for example, from a source such as a food source (e.g., a fermented food or beverage product) or an environmental source (e.g., soil).

### Compositions Comprising Fermentates

Aspects of the present disclosure relate to compositions comprising fermentates of bacterial strains. As used herein, the term “fermentate” refers to a product obtained by fermenting a bacterial strain in an environment suitable for fermentation, such as a culture medium (e.g., liquid medium). In some embodiments, the fermentate comprises products produced by the bacterial strain(s) during fermentation. In some embodiments, the fermentate comprises products produced by the bacterial strain(s) during fermentation and components of the culture medium.

In some embodiments, the bacteria are propagated or manufactured using liquid fermenters, which can support the rapid growth of bacterial species. The fermenters may be, for example, stirred tank reactors or disposable wave bioreactors. Culture media such as BL media and EG media, or similar versions of these media, can be used to support the growth of the bacterial species. The bacterial fermentate can be purified and concentrated from the fermentation broth by suitable techniques, such as centrifugation and filtration, and can optionally be dried and lyophilized by suitable techniques such as those known in the art.

In some embodiments, a composition comprising a fermentate of a bacterial strain does not comprise bacterial cells of the bacterial strain. For example, a fermentate may be separated from the bacterial cells that produced the fermentate (e.g., a culture supernatant). Bacterial cells may be separated from fermentate by any suitable method, such as centrifugation or filtration.

In some embodiments, a composition comprising a fermentate of a bacterial strain also comprises bacterial cells of the bacterial strain. In some embodiments, a composition does not comprise live bacterial cells. In some embodiments, the bacterial cells are heat-killed or pasteurized.

In some embodiments, one or more fermentates are in powder form. In some embodiments, each fermentate of a composition is in powder form. Powder is a dry, bulk solid comprised of many discrete, solid, macroscopic particles, which may flow freely when the powder (or a container in which the powder is present) is shaken or tilted. The skilled artisan will appreciate that powder form fermentates may be incorporated into a composition (e.g., with a carrier and in a defined form), where the composition as a whole has a solid form that is not a powder.

Any suitable method may be used to convert a bacterial fermentate to powder form. Non-limiting examples of powder production processes include grinding and agglomeration (e.g., of solid fermentates), crystallization and spray drying (e.g., of liquid fermentates). Advantages of converting a fermentate to powder form include, without limitation, ease of incorporation into a product intended for consumption (e.g., nutritional supplement or food product intended for ingestion or dental supplement intended for chewing), distribution throughout a product to limit the fermentate mixture's effect on taste and texture, and reduction of water activity to improve stability of desired components of a fermentate mixture.

In some embodiments, a bacterial fermentate mixture in powder form has a water content of 10% or less, 9% or less, 8% or less, 7% or less, 6% or less, 5% or less, 4% or less, 3% or less, 2% or less, or 1% or less.

In some embodiments, one or more fermentates are spray-dried or lyophilized. In some embodiments, one or more fermentates are spray-dried. In some embodiments, each fermentate of a composition is spray-dried. In some embodiments, one or more fermentates are lyophilized. In some embodiments, each fermentate of a composition is lyophilized. Where a fermentate is lyophilized and in powder form, powder may be lyophilized, or a lyophilized non-powder solid may be made into a powder form (e.g., by grinding and/or agglomeration).

Methods of lyophilizing compositions, specifically compositions comprising bacteria, are known in the art. See, e.g., U.S. Pat. Nos. 3,261,761; 4,205,132; and PCT Publication Nos. WO 2014/029578 and WO 2012/098358, herein incorporated by reference in their entirety. Fermentates may be lyophilized as a combination and/or the fermentates may be lyophilized separately and combined prior to incorporation into a composition, nutritional supplement, dental supplement, and/or food product. A fermentate may be combined with a nutrient or carrier prior to combining it with another fermentate or multiple lyophilized fermentates may be combined while in lyophilized form and the mixture of fermentates, once combined may subsequently be combined with a nutrient and/or excipient. In some embodiments, the fermentate or combination thereof is a lyophilized cake. In such embodiments, the fermentate(s) may be rehydrated or suspended and/or cultured prior to use. In some embodiments, the fermentate(s) in lyophilized form are used directly, for example, without rehydrating or suspension (e.g., directly added to a medium).

The process of spray-drying refers to production of a dry powder from a liquid comprising a component, such as a fermentate. See, e.g., Ledet et al., Spray-Drying of Pharmaceuticals in “Lyophilized Biologics and Vaccines” pages 273-194, Springer. In general, the process involves rapidly drying the fermentates with a hot gas. A fermentate may be combined with an excipient or nutrient prior to combining it with other fermentates, or multiple spray-dried fermentates may be combined while in spray-dried form and the mixture of fermentates, once combined, may be subsequently combined with an excipient, carrier, or nutrient.

The amount of fermentate in a composition is quantified according to dry weight of the fermentate. In some embodiments, a fermentate is present in a composition at an amount of 10 to 500 mg. In some embodiments, a fermentate is present in a composition at an amount of 10 to 450, 10 to 400, 10 to 350, 10 to 300, 10 to 250, 10 to 200, 10 to 150, 10 to 100, or 10 to 50 mg. In some embodiments, a fermentate is present in a composition at an amount of 50 to 500, 100 to 500, 150 to 500, 200 to 500, 250 to 500, 300 to 500, 350 to 500, 400 to 500, or 450 to 500 mg. In some embodiments, a fermentate is present in a composition at an amount of 10 to 50, 50 to 100, 100 to 150, 150 to 200, 200 to 250, 250 to 300, 300 to 350, 350 to 400, 400 to 450, or 450 to 500 mg.

In some embodiments, the total mass of fermentates in a composition is 10 to 500 mg. In some embodiments, the total mass of fermentates in a composition is 10 to 450, 10 to 400, 10 to 350, 10 to 300, 10 to 250, 10 to 200, 10 to 150, 10 to 100, or 10 to 50 mg. In some embodiments, the total mass of fermentates in a composition is 50 to 500, 100 to 500, 150 to 500, 200 to 500, 250 to 500, 300 to 500, 350 to 500, 400 to 500, or 450 to 500 mg. In some embodiments, the total mass of fermentates in a composition is 10 to 50, 50 to 100, 100 to 150, 150 to 200, 200 to 250, 250 to 300, 300 to 350, 350 to 400, 400 to 450, or 450 to 500 mg.

### Nutritional Supplements, Dental Supplements, and Food Products

Some aspects relate to a nutritional supplement comprising any of the compositions or fermentates described herein. Some aspects relate to a dental supplement comprising any of the compositions or fermentates described herein. Some aspects relate to a food product comprising any of the compositions or fermentates described herein. Food products and nutritional supplements are, in general, intended for the consumption of a human or other animal, such as a companion animal (e.g., a dog), or a bird. As will be appreciated by one of ordinary skill in the art, a food product provides a primary caloric and nutritive source intended for consumption by a subject (e.g., a feed or treat). In contrast, a nutritional supplement is not intended to provide a primary caloric or nutritive source for a subject but rather provides a targeted effect. Nutritional supplements may provide additional nutrients or functional ingredients that complement a standard diet, e.g., a standard pet diet. Dental supplements may be consumed, or be chewed without consuming (e.g., chewed and then spit out), by a human or other animal. Dental supplements are useful, for example, to exercise an animal's teeth and jaws, and to remove bacterial biofilm, plaque, tartar, and/or dental calculus. Any of the bacterial strains, fermentates thereof, or combinations thereof described herein may be present in a nutritional supplement, dental supplement, or food product. The compositions disclosed herein can be used in a food or beverage, such as a health food, a pet food, a functional food, a dietary supplement, a food or beverage for patients, or an animal feed.

Non-limiting examples of the forms of nutritional and/or dental supplements include carbohydrate-containing foods such as rice food products; paste products such as fish hams, sausages, paste products of seafood; pouch products. Further, the examples also include food products, nutritional supplements, and dental supplements prepared in the forms of powders, granules, kibbles, tablets, capsules, liquids, pastes, chews, and jellies.

Any suitable form may be used for a food product, nutritional supplement, or dental supplement. Non-limiting examples of form factors include dental sticks, dental chews, chews with softer interiors than exteriors, kibbles, and spreads. Additional examples of form factors include a gelatinized starch matrix, extruded or injection-molded dental stick, extruded or injection-molded dental chew, chew having a soft interior, powder meal topper, water additive, dry kibble or food, wet food, frozen food, liquid spray, peanut butter spread, and soft jerky chew.

In some embodiments, the nutritional or dental supplement is an extruded dental stick. In some embodiments, the nutritional or dental supplement is an injection-molded dental stick. In some embodiments, the nutritional or dental supplement is a chew having a soft interior. In some embodiments, the food product, nutritional supplement or dental supplement is a kibble. In some embodiments, the kibble is an extruded kibble. Extruded and/or injection-molded chews, sticks, and kibbles are known in the art, and any suitable method may be used to manufacture such chews, sticks, and kibbles.

In some embodiments, the food product, nutritional supplement or dental supplement is in the form of a wet food. In some embodiments, the food product, nutritional supplement or dental supplement is in the form of a frozen food. Wet foods and frozen foods may be in any suitable form, such as those described in Niamnuy, C., & Devahastin, S. (2010). 11 Pet Foods and Their Physicochemical Properties as Affected by Processing. Contemporary Food Engineering, 327.

In some embodiments, the food product, nutritional supplement, or dental supplement is a soft jerky chew. Jerky chews may be made from any suitable starting material, such as dried meat. In some embodiments, the food product, nutritional supplement, or dental supplement is a spread. In some embodiments, the spread comprises one or more nuts. In some embodiments, the spread is a peanut butter spread. The skilled artisan will appreciate that a food product or supplement intended for consumption by a particular animal will not contain ingredients that are toxic to that animal (e.g., macadamia nuts for dogs).

In some embodiments, the nutritional supplement is an additive. Additives may be added to other foods or food products before consumption by an animal. In some embodiments, the nutritional supplement is a water additive. Water additives are added to drinking water. In some embodiments, the nutritional supplement is a meal topper. Meal toppers may be added directly to food before consumption, with or without incorporation before consumption. In some embodiments, the meal topper is in powder form (a powder meal topper). In some embodiments, the nutritional supplement is a liquid spray. Liquid sprays may be administered directly to an animal, or sprayed on food or in water, with or without incorporation before consumption.

In some embodiments, the nutritional supplement, dental supplement, or food product comprises a fermentate or combination thereof, and a carrier. The carrier may contain any combination of nutrients, excipients, diluents, and/or binders. In some embodiments, the carrier comprises one or more of the following compounds: water, glycerol, ethylene glycol, 1,2-propylene glycol or 1,3-propylene glycol, sodium chloride, sodium benzoate, potassium sorbate, sodium sulfate, potassium sulfate, magnesium sulfate, sodium thiosulfate, calcium carbonate, sodium citrate, dextrin, maltodextrin, glucose, sucrose, sorbitol, lactose, whey, whey permeate, wheat flour, wheat bran, corn gluten meal, starch and cellulose. In some embodiments, the carrier is a gelatinized starch matrix. In some embodiments, the carrier is maltodextrin. In some embodiments, the carrier is a tapioca-based maltodextrin. Any suitable method may be used to obtain maltodextrin from tapioca, such as isolation from a tapioca plant.

In some embodiments, the carrier is present in a 2:1, 3:1, 4:1, 5:1, 6:1, 7:1, 8:1, 9:1, or 10:1 ratio by weight relative to the total amount of fermentates. In some embodiments, the carrier is present in a 1:2, 1:3, 1:4, 1:5, 1:6, 1:7, 1:8, 1:9, or 1:10 ratio by weight relative to the total amount of fermentates. In some embodiments, the carrier is present in a 2:1 ratio by weight relative to the total amount of fermentates. In some embodiments, the carrier is present in a 1:1 ratio by weight relative to the total amount of fermentates. In some embodiments, the carrier is present in a 2:1 ratio by weight relative to each fermentate. In some embodiments, the carrier is present in a 1:1 ratio by weight relative to each fermentate. In some embodiments, the carrier is present in a 1:1 ratio by weight relative to each of three fermentates. In some embodiments, the carrier is present in a 2:1 ratio by weight relative to each of two fermentates.

In some embodiments, a nutritional supplement, dental supplement, and/or food product comprises a composition comprising fermentate(s) at an incorporation rate of 0.01% to 20% w/w. As used herein, an “incorporation rate” refers to the weight of the fermentate-containing composition as a percentage of the total weight of the nutritional supplement, or food product. For example, 10 mg of a fermentate-containing composition in a 50 g supplement is present at an incorporation rate of 0.2% w/w. In some embodiments, the incorporation rate is 0.01% to 20% w/w. In some embodiments, the incorporation rate is 0.01% to 15% w/w. In some embodiments, the incorporation rate is 0.01% to 10% w/w. In some embodiments, the incorporation rate is 0.01% to 5% w/w. In some embodiments, the incorporation rate is 0.02% to 10%, 0.03% to 10%, 0.04% to 10%, 0.05% to 10%, 0.06% to 10%, 0.07% to 10%, 0.08% to 10%, 0.09% to 10%, 0.1% to 10%, 0.2% to 10%, 0.3% to 10%, 0.4% to 10%, 0.5% to 10%, 0.6% to 10%, 0.7% to 10%, 0.8% to 10%, 0.9% to 10%, 1% to 10%, 2% to 10%, 3% to 10%, 4% to 10%, 5% to 10%, 6% to 10%, 7% to 10%, 8% to 10%, or 9% to 10% w/w. In some embodiments, the incorporation rate is 0.1% to 10%, 0.1% to 9%, 0.1% to 8%, 0.1% to 7%, 0.1% to 6%, 0.1% to 5%, 0.1% to 4%, 0.1% to 3%, 0.1% to 2%, or 0.1% to 1% w/w. In some embodiments, the incorporation rate is 0.1% to 2%, 2% to 4%, 4% to 6%, 6% to 8%, 8% to 10%, 10% to 15%, or 15% to 20% w/w. In some embodiments, a nutritional supplement, dental supplement, and/or food product comprises a certain mass of a composition comprising fermentate(s). Defined masses of compositions are useful, for example, for supplements and/or food products that may be diluted in food or water before consumption. In some embodiments, 2 to 2,000 mg of a fermentate-containing composition is present in a nutritional supplement, dental supplement, and/or food product. In some embodiments, 20 to 2,000, 20 to 1,800, 20 to 1,600, 20 to 1,400, 20 to 1,200, 20 to 1,000, 20 to 900, 20 to 800, 20 to 700, 20 to 600, 20 to 500, 20 to 400, 20 to 300, 20 to 200, 20 to 100, or 20 to 50 mg of the composition is present. In some embodiments, 50 to 2,000, 100 to 2,000, 200 to 2,000, 300 to 2,000, 400 to 2,000, 500 to 2,000, 600 to 2,000, 700 to 2,000, 800 to 2,000, 900 to 2,000, 1,000 to 2,000, 1,200 to 2,000, 1,400 to 2,000, 1,600 to 2,000, or 1,800 to 2,000 mg of the composition is present. In some embodiments, 100 to 200, 200 to 300, 300 to 400, 400 to 500, 500 to 600, 600 to 700, 700 to 800, 800 to 900, 1,000 to 1,200, 1,200 to 1,400, 1,400 to 1,600, 1,600 to 1,800, or 1,800 to 2,000 mg of the composition is present. In some embodiments, 0.01 to 0.1, 0.1 to 1, 1 to 10, 10 to 100, 100 to 1,000, or 1,000 to 10,000 mg of the composition is present.

A nutritional supplement, dental supplement, and/or food product may comprise one or more nutrients. The nutrient may be a carbohydrate or carbohydrate source. Non-limiting examples of carbohydrate sources include grains, such as corn, rice, milo, sorghum, barley, alfalfa, oats, and wheat. In some embodiments, the nutrient is a grain. In some embodiments, the nutrient is wheat, corn, rice, oats, and/or barley. A nutritional supplement, dental supplement, and/or food product may comprise a gelatinized starch matrix. Matrices of gelatinized starch may comprise any suitable starch, such as a starch listed herein or another starch known in the art.

A nutritional supplement, dental supplement, and/or food product may comprise a fiber. Fibers may add bulk to a composition and may be fermented by intestinal bacteria to produce short-chain fatty acids and other metabolites. Non-limiting examples of fibers include tapioca fiber, beet pulp (e.g., sugar beet pulp), gum arabic, gum talha, psyllium, rice bran, carob bean gum, citrus pulp, pectin, fructooligosaccharide, mannaoligofructose, soy fiber, arabinogalactan, galactooligosaccharide, arabinoxylan, chicory pulp, chicory, coconut endosperm fiber, wheat fiber, and inulin.

A nutritional supplement, dental supplement, and/or food product may comprise an algal strain. Algae may add one or more nutrients and/or bulk to a composition. Non-limiting examples of algal species include Ascophyllum nodosum, Spirulina (e.g., Arthrospira platensis, Arthrospira fusiformis, and Arthrospira maxima), and/or Fucus vesiculosus.

A nutritional supplement, dental supplement, and/or food product may comprise one or more inorganic minerals. Non-limiting examples of minerals include calcium carbonate, calcium, boron, selenium, calcium chloride, chloride, ferrous fumarate, zinc acetate, choline chloride, chromium, ferrous gluconate, zinc sulfate, chromium, tripicolinate, cobalt, magnesium oxide, zinc gluconate, dicalcium phosphate, copper, magnesium sulfate, ferrous sulfate, iodine, magnesium carbonate, monosodium phosphate, iron, chromium picolinate, potassium chloride, magnesium, calcium citrate, potassium citrate, manganese, calcium lactate, potassium sorbate, phosphorus, calcium gluconate, sodium bisulfate, potassium, chromium chloride, sodium hexametaphosphate, sodium, chromium nicotinate, tricalcium phosphate, zinc, and chromium citrate.

A nutritional supplement, dental supplement, and/or food product may comprise one or more protein sources. Non-limiting examples of such protein sources include chicken meals, chicken, chicken byproduct meals, eggs, lamb, lamb meals, turkey, turkey meals, beef, beef byproducts, viscera, fish, fish meal, enterals, kangaroo, white fish, venison, blood marrow, bone marrow, soybean meal, soy protein isolate, and soy protein concentrate.

A nutritional supplement, dental supplement, and/or food product may comprise one or more starches. Non-limiting examples of such starches include cereals, grains, corn, wheat, rice, oats, corn grits, sorghum, grain sorghum, milo, wheat bran, oat bran, amaranth, durum, and semolina.

A nutritional supplement, dental supplement, and/or food product may comprise one or more dairy products. Dairy products include, without limitation, cream, milk, butter, and cheese.

A nutritional supplement, dental supplement, and/or food product may comprise a meat or animal-derived material (e.g., animal-derived protein source). In some embodiments, the meat or animal-derived material is beef, chicken, eggs, turkey, lamb, fish, blood marrow, bone marrow, or a combination of any thereof.

### Methods of Use

Some aspects of the present disclosure relate to administration of a composition (and/or nutritional supplement, dental supplement, and/or food product comprising the same) to a subject in need thereof. Administration may be accomplished through any suitable method, such as one described herein or known in the art, and may include, for example, consumption of the composition (and/or nutritional supplement, dental supplement, and/or food product) by the subject.

In some embodiments, administration is oral. Oral administration may refer to manual administration, such as oral gavage or spraying (e.g., via aerosol). Oral administration may also refer to feeding, such as providing the composition or nutritional supplement to a subject (e.g., a companion animal), which ingests it by eating or drinking. Methods may include a single administration or administration may be repeated. Repeat administrations may be conducted at regular intervals (e.g., daily or weekly). For example, a subject may be administered a composition or supplement one or more times daily, over a specified time period, such as a week, several weeks, a month, or several months. Alternatively, multiple instances of administration may be conducted on an as-needed basis.

In some embodiments, administration is rectal. In some embodiments, a composition, supplement, or food product is in the form of a suppository when administered rectally. In some embodiments, a composition, supplement, or food product is delivered to the intestine. In some embodiments, a composition, supplement, or food product is delivered to the colon. Such delivery to the intestine or colon may be accomplished by oral or rectal administration.

In some embodiments, a composition, nutritional supplement, dental supplement, or food product is administered in an effective amount for treating, preventing, or alleviating one or more symptoms in a subject. An “effective amount” or “effective dosage” refers to an amount or dosage, respectively, sufficient to treat, alleviate, or prevent a sign or symptom in a subject. The actual effective amount or dosage will depend on the individual subject and their health. Such effective amounts or dosages may be determined by routine assays known to those of skill in the art.

Subjects to which a composition, supplement, or food product may be administered include any animal known in the art. In some embodiments, the subject is a human. In some embodiments, the animal is a domesticated animal. In some embodiments, the animal is a carnivore. In some embodiments, the animal is a rodent. In some embodiments, the rodent is a mouse, rat, guinea pig, chinchilla, or hamster. In some embodiments, the animal is a dog, cat, rabbit, guinea pig, hamster, or ferret. In some embodiments, the animal is a dog. In some embodiments, the animal is a bovine, swine, llama, alpaca, sheep, or goat. In some embodiments, the animal is a bird.

In some embodiments, the composition, nutritional supplement, dental supplement, and/or food product is effective in reducing one or more symptoms, such as bad breath, gingivitis, dental calculus buildup, inflammation, diarrhea, vomiting, itching, constipation, lack of appetite, lethargy, arthritis, excessive grooming, abdominal pain, and fever. In some embodiments, the composition, nutritional supplement, dental supplement, and/or food product treats or prevents bad breath in the subject. In some embodiments, the composition, nutritional supplement, dental supplement, and/or food product treats or prevents gingivitis in the subject. In some embodiments, the composition, nutritional supplement, dental supplement, and/or food product treats or prevents dental calculus buildup in the subject. In some embodiments, the composition, nutritional supplement, dental supplement, and/or food product treats or prevents diarrhea in the subject. In some embodiments, the composition, nutritional supplement, dental supplement, and/or food product treats or prevents vomiting or nausea in the subject.

In some embodiments, a composition, nutritional supplement, dental supplement, and/or food product is administered to a subject having halitosis. Signs and symptoms of halitosis include unpleasant breath containing one or more volatile sulfur compounds, gingivitis, and accumulation of plaque, tartar, and/or dental calculus on teeth of the subject. In some embodiments, the oral microenvironment of the subject comprises one or more microorganisms associated with halitosis. Exemplary microorganisms associated with halitosis include, without limitation, Porphyromonas gingivalis, Prevotella intermedia, Porphyromonas canigingivalis, Tannerella forsythia, Treponema denticola, Fusobacterium nucleatum, Neisseria canis, and Bergeyella zoohelcum. In some embodiments, the subject's oral microenvironment comprises Porphyromonas gingivalis. In some embodiments, the subject's oral microenvironment comprises Prevotella intermedia. In some embodiments, the subject's oral microenvironment comprises Porphyromonas canigingivalis. In some embodiments, the subject's oral microenvironment comprises Tannerella forsythia. In some embodiments, the subject's oral microenvironment comprises Treponema denticola. In some embodiments, the subject's oral microenvironment comprises Fusobacterium nucleatum. In some embodiments, the subject's oral microenvironment comprises Neisseria canis. In some embodiments, the subject's oral microenvironment comprises Bergeyella zoohelcum.

Any suitable method may be used to determine whether a subject's oral microenvironment comprises a given microorganism. For example, culture-based methods, microscopy-based methods, 16S rDNA sequencing, and/or whole-genome sequencing-based methods may be performed on a sample obtained from a subject's oral microenvironment. In some embodiments, one or more microorganisms is present in a saliva sample. In some embodiments, one or more microorganisms is present on oral mucosa of a subject. In some embodiments, one or more microorganisms is present on the tongue of a subject. In some embodiments, one or more microorganisms is present on a tooth of a subject.

In some embodiments, the composition, nutritional supplement, dental supplement, and/or food product is effective in treating or preventing one or more symptoms or adverse events in a subject. As discussed above, the compositions reduce VSC abundance, inhibit VSC production, and/or reduce an alkaline oral environment, thereby improving halitosis. In some embodiments, the composition, nutritional supplement, dental supplement, and/or food product reduces VSC abundance in the subject. Methods of measuring VSC abundance are known in the art, and include, without limitation, measuring the concentration of one or more VSCs (e.g., hydrogen sulfide, methyl mercaptan, and dimethyl sulfide) in the subject, such as in a sample obtained from the oral microenvironment (e.g., a breath or saliva sample).

In some embodiments, the composition, nutritional supplement, dental supplement, and/or food product reduces inflammation in the subject. In some embodiments, the composition, nutritional supplement, dental supplement, and/or food product treats or prevents one or more symptoms associated with inflammation. Methods of measuring inflammation are known in the art, and include, without limitation, measuring the concentration of one or more cytokines (e.g., TNF-α, IL-1β, IL-6, IL-10, and IL-12) in the subject, such as in a sample obtained from the subject (e.g., a blood sample, serum sample, plasma sample). In some embodiments, the composition, nutritional supplement, dental supplement, and/or food product reduces infiltration of leukocytes (e.g., neutrophils and/or monocytes) into oral mucosa. In some embodiments, the composition, nutritional supplement, dental supplement, and/or food product reduces the rate of plaque accumulation, compared to a reference subject (e.g., a subject that has not been administered the composition or nutritional supplement). In some embodiments, the composition, nutritional supplement, dental supplement, and/or food product reduces the rate of tartar accumulation, compared to a reference subject (e.g., a subject that has not been administered the composition or nutritional supplement). In some embodiments, the composition, nutritional supplement, dental supplement, and/or food product reduces the rate of dental calculus accumulation, compared to a reference subject (e.g., a subject that has not been administered the composition or nutritional supplement).

In some embodiments, administration results in a decrease in abundance of dental plaque by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of dental plaque prior to administering the composition. In some embodiments, administration of a composition results in decrease in the abundance of dental plaque by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of dental plaque in a subject (e.g., a reference subject) who did not receive the composition.

In some embodiments, administration results in a decrease in abundance of dental tartar by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of dental tartar prior to administering the composition. In some embodiments, administration of a composition results in decrease in the abundance of dental tartar by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of dental tartar in a subject (e.g., a reference subject) who did not receive the composition.

In some embodiments, administration results in a decrease in abundance of dental calculus by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of dental calculus prior to administering the composition. In some embodiments, administration of a composition results in decrease in the abundance of dental calculus by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of dental calculus in a subject (e.g., a reference subject) who did not receive the composition.

In some embodiments, administration of a composition results in a decrease in abundance of one or more microorganisms in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of one or more microorganisms in the subject (or microbiome thereof) prior to administering the composition. In some embodiments, administration of the composition results in a decrease in abundance of one or more microorganisms in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of one or more microorganisms in another subject (e.g., a reference subject)(or microbiome thereof) who did not receive the composition.

In some embodiments, administration results in a decrease in abundance of one or more microorganisms in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of the microorganism in the subject (or microbiome thereof) prior to administering the composition. In some embodiments, administration of a composition results in decrease in the abundance of one or more microorganisms in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of the microorganisms in a subject (e.g., a reference subject)(or microbiome thereof) who did not receive the composition.

In some embodiments, administration of a composition results in a decrease in abundance of Porphyromonas gingivalis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas gingivalis in the subject (or microbiome thereof) prior to administering the composition. In some embodiments, administration of the composition results in a decrease in abundance of Porphyromonas gingivalis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas gingivalis in another subject (e.g., a reference subject)(or microbiome thereof) who did not receive the composition.

In some embodiments, administration results in a decrease in abundance of Porphyromonas gingivalis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Porphyromonas gingivalis in the subject (or microbiome thereof) prior to administering the composition. In some embodiments, administration of a composition results in decrease in the abundance of Porphyromonas gingivalis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Porphyromonas gingivalis in a subject (e.g., a reference subject)(or microbiome thereof) who did not receive the composition.

In some embodiments, administration of a composition results in a decrease in abundance of Prevotella intermedia in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Prevotella intermedia in the subject (or microbiome thereof) prior to administering the composition. In some embodiments, administration of the composition results in a decrease in abundance of Prevotella intermedia in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Prevotella intermedia in another subject (e.g., a reference subject)(or microbiome thereof) who did not receive the composition.

In some embodiments, administration results in a decrease in abundance of Prevotella intermedia in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Prevotella intermedia in the subject (or microbiome thereof) prior to administering the composition. In some embodiments, administration of a composition results in decrease in the abundance of Prevotella intermedia in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Prevotella intermedia in a subject (e.g., a reference subject)(or microbiome thereof) who did not receive the composition.

In some embodiments, administration of a composition results in a decrease in abundance of Porphyromonas canigingivalis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas canigingivalis in the subject (or microbiome thereof) prior to administering the composition. In some embodiments, administration of the composition results in a decrease in abundance of Porphyromonas canigingivalis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas canigingivalis in another subject (e.g., a reference subject)(or microbiome thereof) who did not receive the composition.

In some embodiments, administration results in a decrease in abundance of Porphyromonas canigingivalis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Porphyromonas canigingivalis in the subject (or microbiome thereof) prior to administering the composition. In some embodiments, administration of a composition results in decrease in the abundance of Porphyromonas canigingivalis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Porphyromonas canigingivalis in a subject (e.g., a reference subject)(or microbiome thereof) who did not receive the composition.

In some embodiments, administration of a composition results in a decrease in abundance of Tannerella forsythia in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Tannerella forsythia in the subject (or microbiome thereof) prior to administering the composition. In some embodiments, administration of the composition results in a decrease in abundance of Tannerella forsythia in the subject (or microbiome thereof) by at or more, as compared to the abundance of Tannerella forsythia in another subject (e.g., a reference subject)(or microbiome thereof) who did not receive the composition.

In some embodiments, administration results in a decrease in abundance of Tannerella forsythia in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Tannerella forsythia in the subject (or microbiome thereof) prior to administering the composition. In some embodiments, administration of a composition results in decrease in the abundance of Tannerella forsythia in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Tannerella forsythia in a subject (e.g., a reference subject)(or microbiome thereof) who did not receive the composition.

In some embodiments, administration of a composition results in a decrease in abundance of Treponema denticola in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Treponema denticola in the subject (or microbiome thereof) prior to administering the composition. In some embodiments, administration of the composition results in a decrease in abundance of Treponema denticola in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Treponema denticola in another subject (e.g., a reference subject)(or microbiome thereof) who did not receive the composition.

In some embodiments, administration results in a decrease in abundance of Treponema denticola in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Treponema denticola in the subject (or microbiome thereof) prior to administering the composition. In some embodiments, administration of a composition results in decrease in the abundance of Treponema denticola in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Treponema denticola in a subject (e.g., a reference subject)(or microbiome thereof) who did not receive the composition.

In some embodiments, administration of a composition results in a decrease in abundance of Fusobacterium nucleatum in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Fusobacterium nucleatum in the subject (or microbiome thereof) prior to administering the composition. In some embodiments, administration of the composition results in a decrease in abundance of Fusobacterium nucleatum in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Fusobacterium nucleatum in another subject (e.g., a reference subject)(or microbiome thereof) who did not receive the composition.

In some embodiments, administration results in a decrease in abundance of Fusobacterium nucleatum in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Fusobacterium nucleatum in the subject (or microbiome thereof) prior to administering the composition. In some embodiments, administration of a composition results in decrease in the abundance of Fusobacterium nucleatum in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Fusobacterium nucleatum in a subject (e.g., a reference subject)(or microbiome thereof) who did not receive the composition.

In some embodiments, administration of a composition results in a decrease in abundance of Neisseria canis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Neisseria canis in the subject (or microbiome thereof) prior to administering the composition. In some embodiments, administration of the composition results in a decrease in abundance of Neisseria canis in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Neisseria canis in another subject (e.g., a reference subject)(or microbiome thereof) who did not receive the composition.

In some embodiments, administration results in a decrease in abundance of Neisseria canis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Neisseria canis in the subject (or microbiome thereof) prior to administering the composition. In some embodiments, administration of a composition results in decrease in the abundance of Neisseria canis in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Neisseria canis in a subject (e.g., a reference subject)(or microbiome thereof) who did not receive the composition.

In some embodiments, administration of a composition results in a decrease in abundance of Bergeyella zoohelcum in the subject (or microbiome thereof) by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Bergeyella zoohelcum in the subject (or microbiome thereof) prior to administering the composition. In some embodiments, administration of the composition results in a decrease in abundance of Bergeyella zoohelcum in the subject (or microbiome thereof) by at or more, as compared to the abundance of Bergeyella zoohelcum in another subject (e.g., a reference subject)(or microbiome thereof) who did not receive the composition.

In some embodiments, administration results in a decrease in abundance of Bergeyella zoohelcum in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Bergeyella zoohelcum in the subject (or microbiome thereof) prior to administering the composition. In some embodiments, administration of a composition results in decrease in the abundance of Bergeyella zoohelcum in the subject (or microbiome thereof) by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, 100%, 125%, 150% or more, as compared to the abundance of Bergeyella zoohelcum in a subject (e.g., a reference subject)(or microbiome thereof) who did not receive the composition.

In some embodiments, administration reduces the concentration of 1, 2, 3, 4, 5, 6, 7, 8, 9, 10, 11, 12, 13, 14, 15, 16, 17, 18, 19, or 20 VSCs with distinct structures in the oral microenvironment of the subject. In some embodiments, administration reduces the concentration of 1, 2, or 3 VSCs with distinct structures. In some embodiments, administration reduces the concentration of hydrogen sulfide. In some embodiments, administration reduces the concentration of methyl mercaptan. In some embodiments, administration reduces the concentration of dimethyl sulfide.

In some embodiments, administration reduces the concentration of VSCs in an oral microenvironment by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, administration reduces the concentration of VSCs by 5-10%, 10-20%, 20-30%, 30-40%, 40-50%, 50-60%, 60-70%, 70-80%, 80-90%, or 90-100%. In some embodiments, administration reduces the concentration of VSCs by 5-95%, 5-90%, 5-80%, 5-70%, 5-60%, 5-50%, 5-40%, 5-30%, 5-25%, 5-20%, 5-15%, or 5-10%. In some embodiments, administration reduces the concentration of VSCs by 5-99%, 10-99%, 15-99%, 20-99%, 25-99%, 30-99%, 40-99%, 50-99%, 60-99%, 70-99%, 80-99%, or 90-99%.

In some embodiments, administration reduces the concentration of hydrogen sulfide in an oral microenvironment by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, administration reduces the concentration of hydrogen sulfide by 5-10%, 10-20%, 20-30%, 30-40%, 40-50%, 50-60%, 60-70%, 70-80%, 80-90%, or 90-100%. In some embodiments, administration reduces the concentration of hydrogen sulfide by 5-95%, 5-90%, 5-80%, 5-70%, 5-60%, 5-50%, 5-40%, 5-30%, 5-25%, 5-20%, 5-15%, or 5-10%. In some embodiments, administration reduces the concentration of hydrogen sulfide by 5-99%, 10-99%, 15-99%, 20-99%, 25-99%, 30-99%, 40-99%, 50-99%, 60-99%, 70-99%, 80-99%, or 90-99%.

In some embodiments, administration reduces the concentration of methyl mercaptan in an oral microenvironment by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, administration reduces the concentration of methyl mercaptan by 5-10%, 10-20%, 20-30%, 30-40%, 40-50%, 50-60%, 60-70%, 70-80%, 80-90%, or 90-100%. In some embodiments, administration reduces the concentration of methyl mercaptan by 5-95%, 5-90%, 5-80%, 5-70%, 5-60%, 5-50%, 5-40%, 5-30%, 5-25%, 5-20%, 5-15%, or 5-10%. In some embodiments, administration reduces the concentration of methyl mercaptan by 5-99%, 10-99%, 15-99%, 20-99%, 25-99%, 30-99%, 40-99%, 50-99%, 60-99%, 70-99%, 80-99%, or 90-99%.

In some embodiments, administration reduces the concentration of dimethyl sulfide in an oral microenvironment by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, administration reduces the concentration of dimethyl sulfide by 5-10%, 10-20%, 20-30%, 30-40%, 40-50%, 50-60%, 60-70%, 70-80%, 80-90%, or 90-100%. In some embodiments, administration reduces the concentration of dimethyl sulfide by 5-95%, 5-90%, 5-80%, 5-70%, 5-60%, 5-50%, 5-40%, 5-30%, 5-25%, 5-20%, 5-15%, or 5-10%. In some embodiments, administration reduces the concentration of dimethyl sulfide by 5-99%, 10-99%, 15-99%, 20-99%, 25-99%, 30-99%, 40-99%, 50-99%, 60-99%, 70-99%, 80-99%, or 90-99%.

The extent to which a composition or nutritional supplement treats or prevents a symptom may be evaluated using methods known in the art, such as monitoring the change in the frequency, occurrence, and/or severity of symptoms following administration of the composition or nutritional supplement. Additionally, groups of subjects administered the bacterial mixture, composition, or nutritional supplement may be monitored and compared to another group of subjects that was not administered the composition or nutritional supplement, a group that was administered a different amount of the composition or nutritional supplement, and/or a group that was administered a control composition (e.g., a carrier or excipient lacking the fermentate(s)).

Reduction of Volatile Sulfur Compounds (VSCs) Abundance and/or Inhibition of VSC Production

Fermentates of bacterial strains for use in the compositions described herein were identified based on the ability to reduce the abundance of volatile sulfur compounds (VSCs) in an environment and/or inhibit the production of VSCs by other microorganisms in the environment. VSCs are associated with the unpleasant odor of breath of subjects with halitosis, and reduction in VSC abundance (e.g., by VSC metabolism or inhibition of VSC production) is expected to alleviate this symptom of halitosis. Non-limiting examples of such VSCs include hydrogen sulfide, methyl mercaptan, and dimethyl sulfide, all of which give off strong and unpleasant odors.

In some embodiments, a composition, nutritional supplement, dental supplement, and/or food product reduces the abundance of one or more microorganisms associated with halitosis in the subject or the subject's oral microenvironment. In some embodiments, a composition, nutritional supplement, dental supplement, and/or food product alleviates one or more signs and symptoms of halitosis in a subject. Signs and symptoms of halitosis include unpleasant breath containing one or more volatile sulfur compounds, gingivitis, and accumulation of plaque, tartar, and/or dental calculus on teeth of the subject.

In some embodiments, a composition comprising a fermentate (and/or a nutritional supplement, dental supplement, and/or food product comprising the same) reduces the concentration of 1, 2, 3, 4, 5, 6, 7, 8, 9, 10, 11, 12, 13, 14, 15, 16, 17, 18, 19, or 20 VSCs with distinct structures. In some embodiments, the composition reduces the concentration of 1, 2, or 3 VSCs with distinct structures. In some embodiments, the composition reduces the concentration of hydrogen sulfide. In some embodiments, the composition reduces the concentration of methyl mercaptan. In some embodiments, the composition reduces the concentration of dimethyl sulfide.

In some embodiments, the composition reduces the concentration of VSCs by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, the composition reduces the concentration of VSCs by 5-10%, 10-20%, 20-30%, 30-40%, 40-50%, 50-60%, 60-70%, 70-80%, 80-90%, or 90-100%. In some embodiments, the composition reduces the concentration of VSCs by 5-95%, 5-90%, 5-80%, 5-70%, 5-60%, 5-50%, 5-40%, 5-30%, 5-25%, 5-20%, 5-15%, or 5-10%. In some embodiments, the composition reduces the concentration of VSCs by 5-99%, 10-99%, 15-99%, 20-99%, 25-99%, 30-99%, 40-99%, 50-99%, 60-99%, 70-99%, 80-99%, or 90-99%.

In some embodiments, the composition reduces the concentration of hydrogen sulfide by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, the composition reduces the concentration of hydrogen sulfide by 5-10%, 10-20%, 20-30%, 30-40%, 40-50%, 50-60%, 60-70%, 70-80%, 80-90%, or 90-100%. In some embodiments, the composition reduces the concentration of hydrogen sulfide by 5-95%, 5-90%, 5-80%, 5-70%, 5-60%, 5-50%, 5-40%, 5-30%, 5-25%, 5-20%, 5-15%, or 5-10%. In some embodiments, the composition reduces the concentration of hydrogen sulfide by 5-99%, 10-99%, 15-99%, 20-99%, 25-99%, 30-99%, 40-99%, 50-99%, 60-99%, 70-99%, 80-99%, or 90-99%.

In some embodiments, the composition reduces the concentration of methyl mercaptan by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, the composition reduces the concentration of methyl mercaptan by 5-10%, 10-20%, 20-30%, 30-40%, 40-50%, 50-60%, 60-70%, 70-80%, 80-90%, or 90-100%. In some embodiments, the composition reduces the concentration of methyl mercaptan by 5-95%, 5-90%, 5-80%, 5-70%, 5-60%, 5-50%, 5-40%, 5-30%, 5-25%, 5-20%, 5-15%, or 5-10%. In some embodiments, the composition reduces the concentration of methyl mercaptan by 5-99%, 10-99%, 15-99%, 20-99%, 25-99%, 30-99%, 40-99%, 50-99%, 60-99%, 70-99%, 80-99%, or 90-99%.

In some embodiments, the composition reduces the concentration of dimethyl sulfide by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, the composition reduces the concentration of dimethyl sulfide by 5-10%, 10-20%, 20-30%, 30-40%, 40-50%, 50-60%, 60-70%, 70-80%, 80-90%, or 90-100%. In some embodiments, the composition reduces the concentration of dimethyl sulfide by 5-95%, 5-90%, 5-80%, 5-70%, 5-60%, 5-50%, 5-40%, 5-30%, 5-25%, 5-20%, 5-15%, or 5-10%. In some embodiments, the composition reduces the concentration of dimethyl sulfide by 5-99%, 10-99%, 15-99%, 20-99%, 25-99%, 30-99%, 40-99%, 50-99%, 60-99%, 70-99%, 80-99%, or 90-99%.

Not all fermentates must reduce, or be produced by bacterial strains that reduce, the concentration of VSCs. Some bacterial strains and fermentates thereof may (i) produce one or more antioxidants; (ii) enhance the ability of other bacterial strains or fermentates thereof to reduce VSC concentration; (iii) inhibit VSC production by other microorganisms; and/or (iv) disrupt a biofilm of one or more oral microbes.

In some embodiments, a composition comprises one or more antioxidants. In some embodiments a fermentate comprises one or more antioxidants. In some embodiments, a fermentate is produced by a bacterial strain that produces one or more antioxidants.

In some embodiments, a composition comprises one or more organic acids. In some embodiments a fermentate comprises one or more organic acids. In some embodiments, a fermentate is produced by a bacterial strain that produces one or more organic acids. Non-limiting examples of organic acids include lactic acid, ascorbic acid, acetic acid, acrylic acid, propionic acid, pyruvic acid, and citric acid.

In some embodiments, a composition enhances the ability of one or more other fermentates to reduce the concentration of VSCs. In some embodiments, a fermentate enhances the ability of one or more other fermentates to reduce the concentration of VSCs. In some embodiments, a fermentate is produced by a bacterial strain that enhances the ability of one or more other fermentates or bacterial strains to reduce the concentration of VSCs.

In some embodiments, a composition inhibits VSC production by another microorganism. In some embodiments, a fermentate inhibits VSC production by another microorganism. In some embodiments, a fermentate is produced by a bacterial strain that inhibits VSC production by another microorganism. In some embodiments, VSC production by Porphyromonas gingivalis is inhibited. In some embodiments, VSC production by Prevotella intermedia is inhibited. In some embodiments, VSC production by Porphyromonas canigingivalis is inhibited. In some embodiments, VSC production by Tannerella forsythia is inhibited. In some embodiments, VSC production by Treponema denticola is inhibited. In some embodiments, VSC production by Fusobacterium nucleatum is inhibited. In some embodiments, VSC production by Neisseria canis is inhibited. In some embodiments, VSC production by Bergeyella zoohelcum is inhibited.

In some embodiments, a composition inhibits hydrogen sulfide production by another microorganism. In some embodiments, a fermentate inhibits hydrogen sulfide production by another microorganism. In some embodiments, a fermentate is produced by a bacterial strain that inhibits hydrogen sulfide production by another microorganism. In some embodiments, hydrogen sulfide production by Porphyromonas gingivalis is inhibited. In some embodiments, hydrogen sulfide production by Prevotella intermedia is inhibited. In some embodiments, hydrogen sulfide production by Porphyromonas canigingivalis is inhibited. In some embodiments, hydrogen sulfide production by Tannerella forsythia is inhibited. In some embodiments, hydrogen sulfide production by Treponema denticola is inhibited. In some embodiments, hydrogen sulfide production by Fusobacterium nucleatum is inhibited. In some embodiments, hydrogen sulfide production by Neisseria canis is inhibited. In some embodiments, hydrogen sulfide production by Bergeyella zoohelcum is inhibited.

In some embodiments, a composition inhibits methyl mercaptan production by another microorganism. In some embodiments, a fermentate inhibits methyl mercaptan production by another microorganism. In some embodiments, a fermentate is produced by a bacterial strain that inhibits methyl mercaptan production by another microorganism. In some embodiments, methyl mercaptan production by Porphyromonas gingivalis is inhibited. In some embodiments, methyl mercaptan production by Prevotella intermedia is inhibited. In some embodiments, methyl mercaptan production by Porphyromonas canigingivalis is inhibited. In some embodiments, methyl mercaptan production by Tannerella forsythia is inhibited. In some embodiments, methyl mercaptan production by Treponema denticola is inhibited. In some embodiments, methyl mercaptan production by Fusobacterium nucleatum is inhibited. In some embodiments, methyl mercaptan production by Neisseria canis is inhibited. In some embodiments, methyl mercaptan production by Bergeyella zoohelcum is inhibited.

In some embodiments, a composition inhibits dimethyl sulfide production by another microorganism. In some embodiments, a fermentate inhibits dimethyl sulfide production by another microorganism. In some embodiments, a fermentate is produced by a bacterial strain that inhibits dimethyl sulfide production by another microorganism. In some embodiments, dimethyl sulfide production by Porphyromonas gingivalis is inhibited. In some embodiments, dimethyl sulfide production by Prevotella intermedia is inhibited. In some embodiments, dimethyl sulfide production by Porphyromonas canigingivalis is inhibited. In some embodiments, dimethyl sulfide production by Tannerella forsythia is inhibited. In some embodiments, dimethyl sulfide production by Treponema denticola is inhibited. In some embodiments, dimethyl sulfide production by Fusobacterium nucleatum is inhibited. In some embodiments, dimethyl sulfide production by Neisseria canis is inhibited. In some embodiments, dimethyl sulfide production by Bergeyella zoohelcum is inhibited.

In some embodiments, a composition reduces the abundance in an oral cavity of a subject of one or more microorganisms that produce VSCs. In some embodiments, a fermentate reduces the abundance in an oral cavity of a subject of one or more microorganisms that produce VSCs. In some embodiments, a fermentate is produced by a bacterial strain that reduces the abundance in an oral cavity of a subject of one or more microorganisms that produce VSCs. In some embodiments, the abundance of Porphyromonas gingivalis is reduced. In some embodiments, the abundance of Prevotella intermedia is reduced. In some embodiments, the abundance of Porphyromonas canigingivalis is reduced. In some embodiments, the abundance of Tannerella forsythia is reduced. In some embodiments, the abundance of Treponema denticola is reduced. In some embodiments, the abundance of Fusobacterium nucleatum is reduced. In some embodiments, the abundance of Neisseria canis is reduced. In some embodiments, the abundance of Bergeyella zoohelcum is reduced.

In some embodiments, the abundance of Porphyromonas gingivalis in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas gingivalis in the oral cavity (or microbiome thereof) prior to exposure to the composition or fermentate(s). In some embodiments, the abundance of Porphyromonas gingivalis in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Porphyromonas gingivalis in the oral cavity (or microbiome thereof) prior to exposure to the composition or fermentate(s).

In some embodiments, the abundance of Prevotella intermedia in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Prevotella intermedia in the oral cavity (or microbiome thereof) prior to exposure to the composition or fermentate(s). In some embodiments, the abundance of Prevotella intermedia in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Prevotella intermedia in the oral cavity (or microbiome thereof) prior to exposure to the composition or fermentate(s).

In some embodiments, the abundance of Porphyromonas canigingivalis in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Porphyromonas canigingivalis in the oral cavity (or microbiome thereof) prior to exposure to the composition or fermentate(s). In some embodiments, the abundance of Porphyromonas canigingivalis in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Porphyromonas canigingivalis in the oral cavity (or microbiome thereof) prior to exposure to the composition or fermentate(s).

In some embodiments, the abundance of Tannerella forsythia in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Tannerella forsythia in the oral cavity (or microbiome thereof) prior to exposure to the composition or fermentate(s). In some embodiments, the abundance of Tannerella forsythia in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Tannerella forsythia in the oral cavity (or microbiome thereof) prior to exposure to the composition or fermentate(s).

In some embodiments, the abundance of Treponema denticola in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Treponema denticola in the oral cavity (or microbiome thereof) prior to exposure to the composition or fermentate(s). In some embodiments, the abundance of Treponema denticola in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Treponema denticola in the oral cavity (or microbiome thereof) prior to exposure to the composition or fermentate(s).

In some embodiments, the abundance of Fusobacterium nucleatum in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Fusobacterium nucleatum in the oral cavity (or microbiome thereof) prior to exposure to the composition or fermentate(s). In some embodiments, the abundance of Fusobacterium nucleatum in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Fusobacterium nucleatum in the oral cavity (or microbiome thereof) prior to exposure to the composition or fermentate(s).

In some embodiments, the abundance of Neisseria canis in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Neisseria canis in the oral cavity (or microbiome thereof) prior to exposure to the composition or fermentate(s). In some embodiments, the abundance of Neisseria canis in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Neisseria canis in the oral cavity (or microbiome thereof) prior to exposure to the composition or fermentate(s).

In some embodiments, the abundance of Bergeyella zoohelcum in the oral cavity (or microbiome thereof) is reduced by at least 1.1-fold, 1.2-fold, 1.3-fold, 1.4-fold, 1.5-fold, 2-fold, 3-fold, 4-fold, 5-fold, 6-fold, 7-fold, 8-fold, 9-fold, 10-fold, 20-fold, 30-fold, 40-fold, 50-fold, 100-fold, 1000-fold, 10⁴-fold, 10⁵-fold or more, as compared to the abundance of Bergeyella zoohelcum in the oral cavity (or microbiome thereof) prior to exposure to the composition or fermentate(s). In some embodiments, the abundance of Bergeyella zoohelcum in the oral cavity (or microbiome thereof) is reduced by at least by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the abundance of Bergeyella zoohelcum in the oral cavity (or microbiome thereof) prior to exposure to the composition or fermentate(s).

In some embodiments, a composition reduces the level of gum inflammation in a subject. In some embodiments, a fermentate reduces the level of gum inflammation in a subject. In some embodiments, a fermentate is produced by a bacterial strain that reduces the level of gum inflammation in a subject. In some embodiments, the level of gum inflammation is reduced by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the level of gum inflammation in the oral cavity prior to exposure to the composition or fermentate.

In some embodiments, a composition reduces the level of gingivitis in an oral cavity of a subject. In some embodiments, a fermentate reduces the level of gingivitis in an oral cavity of a subject. In some embodiments, a fermentate is produced by a bacterial strain that reduces the level of gingivitis in an oral cavity of a subject. In some embodiments, the level of gingivitis is reduced by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the level of gingivitis in the oral cavity prior to exposure to the composition or fermentate.

In some embodiments, a composition reduces the level of plaque in an oral cavity of a subject. In some embodiments, a fermentate reduces the level of plaque in an oral cavity of a subject. In some embodiments, a fermentate is produced by a bacterial strain that reduces the level of plaque in an oral cavity of a subject. In some embodiments, the level of plaque is reduced by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the level of plaque in the oral cavity prior to exposure to the composition or fermentate.

In some embodiments, a composition reduces the level of tartar in an oral cavity of a subject. In some embodiments, a fermentate reduces the level of tartar in an oral cavity of a subject. In some embodiments, a fermentate is produced by a bacterial strain that reduces the level of tartar in an oral cavity of a subject. In some embodiments, the level of tartar is reduced by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the level of tartar in the oral cavity prior to exposure to the composition or fermentate.

In some embodiments, a composition reduces the level of dental calculus accumulation in an oral cavity of a subject. In some embodiments, a fermentate reduces the level of dental calculus accumulation in an oral cavity of a subject. In some embodiments, a fermentate is produced by a bacterial strain that reduces the level of dental calculus accumulation in an oral cavity of a subject. In some embodiments, the level of dental calculus accumulation is reduced by at least 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 35%, 40%, 45%, 50%, 55%, 60%, 65%, 70%, 75%, 80%, 85%, 90%, 95%, or 100%, as compared to the level of dental calculus accumulation in the oral cavity prior to exposure to the composition or fermentate.

In some embodiments, a composition disrupts a biofilm of one or more oral microbes. In some embodiments, a fermentate disrupts a biofilm of one or more oral microbes. In some embodiments, a fermentate is produced by a bacterial strain that disrupts a biofilm of one or more oral microbes. In some embodiments, the oral microbe is a canine oral microbe. In some embodiments, the canine oral microbe is Neisseria canis. In some embodiments, the canine oral microbe is Bergeyella zoohelcum. In some embodiments, the composition reduces the surface area of an oral microbe biofilm by at least 5%, at least 10%, at least 15%, at least 20%, at least 25%, at least 30%, at least 35%, at least 40%, at least 45%, at least 50%, at least 55%, at least 60%, at least 65%, at least 70%, at least 75%, at least 80%, at least 85%, at least 90% or at least 95%. In some embodiments, the composition reduces the surface area of an oral microbe biofilm by 5-10%, 10-20%, 20-30%, 30-40%, 40-50%, 50-60%, 60-70%, 70-80%, 80-90%, or 90-100%. In some embodiments, the composition reduces the surface area of an oral microbe biofilm by 5-95%, 5-90%, 5-80%, 5-70%, 5-60%, 5-50%, 5-40%, 5-30%, 5-25%, 5-20%, 5-15%, or 5-10%. In some embodiments, the composition reduces the surface area of an oral microbe biofilm by 5-99%, 10-99%, 15-99%, 20-99%, 25-99%, 30-99%, 40-99%, 50-99%, 60-99%, 70-99%, 80-99%, or 90-99%.

### ENUMERATED EMBODIMENTS

A1. A postbiotic composition comprising
   (a) a fermentate of a first bacterial strain comprising a 16S rDNA sequence with at least 97% sequence identity to the nucleic acid sequence of any one of SEQ ID NOs: 1-4; and
   (b) one or more additional fermentates, wherein each of the one or more additional fermentates are of a bacterial strain comprising a 16S rDNA sequence with at least 97% sequence identity to the nucleic acid sequence of any one of SEQ ID NO: 5-9.
A1.1. The composition of Embodiment A1, wherein the bacterial strain of (a) is capable of disrupting a biofilm of one or more canine oral microbes.
A1.2 The composition of Embodiment A1 or A1.1, wherein the bacterial strain of (b) is capable of
   (i) producing one or more compounds able to reduce the abundance of one or more volatile sulfur compounds (VSCs);
   (ii) producing one or more antioxidants; and/or
   (iii) enhancing a function of one or more bacterial strains.
A1.3. The composition of Embodiment A1.2, wherein the antioxidant is selected from the group consisting of a vitamin, an organic acid, a polyphenol, an indole-containing compound, and a phenol.
A1.4 The composition of Embodiment A1.3, the antioxidant is reactive to the ferric ion-reducing antioxidant power assay.
A2. A postbiotic composition comprising
   (a) a first fermentate of a first bacterial strain comprising a 16S rDNA sequence with at least 97% sequence identity to the nucleic acid sequence of any one of SEQ ID NOs: 1-4; and
   (b) a second fermentate of a second bacterial strain comprising a 16S rDNA sequence with at least 97% sequence identity to the nucleic acid sequence of SEQ ID NO: 5.
A2.1 The composition of Embodiment A2, further comprising:
   (c) a third fermentate of a third bacterial strain comprising a 16s rDNA sequence with at least 97% sequence identity to the nucleic acid sequence of any one of SEQ ID NOs: 6-9.
A2.2 The composition of Embodiment A2.1, wherein
   (a) the first bacterial strain comprises a 16S rDNA sequence with at least 97% sequence identity to the nucleic acid sequence of SEQ ID NO: 1 (B. subtilis);
   (b) the second bacterial strain comprises a 16S rDNA sequence with at least 97% sequence identity to the nucleic acid sequence of SEQ ID NO: 5 (Pediococcus pentosaceus); and
(c) the third bacterial strain comprises a 16S rDNA sequence with at least 97% sequence identity to the nucleic acid sequence of SEQ ID NO: 6 (Lactiplantibacillus plantarum).
A2.3 The composition of Embodiment A2.1, wherein
   (a) the first bacterial strain comprises a 16S rDNA sequence with at least 97% sequence identity to the nucleic acid sequence of SEQ ID NO: 1 (B. subtilis);
   (b) the second bacterial strain comprises a 16S rDNA sequence with at least 97% sequence identity to the nucleic acid sequence of SEQ ID NO: 5 (Pediococcus pentosaceus); and
   (c) the third bacterial strain comprises a 16S rDNA sequence with at least 97% sequence identity to the nucleic acid sequence of SEQ ID NO: 9 (B. subtilis).
A3. A postbiotic composition comprising
   (a) a first fermentate of a first bacterial strain comprising a 16S rDNA sequence with at least 97% sequence identity to the nucleic acid sequence of any one of SEQ ID NOs: 1-4; and
   (b) a second fermentate of a second bacterial strain comprising a 16S rDNA sequence with at least 97% sequence identity to the nucleic acid sequence of any one of SEQ ID NOs: 6-9.
A3.1 The composition of Embodiment A3, further comprising a third fermentate of a third bacterial strain comprising a 16s rDNA sequence with at least 97% sequence identity to the nucleic acid sequence of SEQ ID NO: 5.
A3.2 The composition of Embodiment A3.1, wherein
   (a) the first bacterial strain comprises a 16S rDNA sequence with at least 97% sequence identity to the nucleic acid sequence of SEQ ID NO: 1 (B. subtilis);
   (b) the second bacterial strain comprises a 16S rDNA sequence with at least 97% sequence identity to the nucleic acid sequence of SEQ ID NO: 5 (Lactiplantibacillus plantarum); and
   (c) the third bacterial strain comprises a 16S rDNA sequence with at least 97% sequence identity to the nucleic acid sequence of SEQ ID NO: 6 (Pediococcus pentosaceus).
A4. A postbiotic composition comprising:
   (a) a fermentate of a bacterial strain that disrupts an oral biofilm; and at least one of:
   (b)(i) a fermentate of a bacterial strain that produces one or more compounds able to reduce the abundance of one or more volatile sulfur compounds (VSCs),
   (b)(ii) a fermentate of a bacterial strain that produces one or more antioxidants; and
   (b)(iii) a fermentate of a bacterial strain that enhances a function of one or more bacterial strains.
A4.1 The composition of Embodiment A4, wherein the bacterial strain of (a) is selected from the group consisting of Bacillus subtilis, Bacillus amyloliquefaciens, Bacillus licheniformis, and Bacillus pumilus.
A4.2 The composition of Embodiment A4 or A4.1, wherein the bacterial strain of (b)(i) is Pediococcus pentosaceus.
A4.3 The composition of Embodiment A4 or A4.2, wherein the bacterial strain of (b)(i) is selected from the group consisting of Pediococcus pentosaceus, Bacillus subtilis, and Lactiplantibacillus plantarum.
A4.4 The composition of any one of Embodiments A4-A4.3, wherein the bacterial strain of (b)(ii) is selected from the group consisting of Lactiplantibacillus plantarum, Lactobacillus delbrueckii, and Limosilactobacillus fermentum.
A4.5 The composition of any one of Embodiments A4-A4.4, wherein the bacterial strain of (b)(ii) is selected from the group consisting of Pediococcus pentosaceus, Lactiplantibacillus plantarum, Lactobacillus delbrueckii, and Limosilactobacillus fermentum.
A4.6 The composition of any one of Embodiments A4-A4.5, wherein the bacterial strain of (b)(iii) is selected from the group consisting of Bacillus subtilis and Lactiplantibacillus plantarum.
A5. The composition of any one of the preceding Embodiments, wherein the composition reduces the abundance of one or more volatile sulfur compounds (VSCs) in an oral cavity of a subject.
A6. The composition of any one of the preceding Embodiments, wherein the composition reduces the abundance of one or more volatile sulfur compound (VSC)-producing microorganisms in a subject.
A7. The composition of Embodiment A6, wherein the one or more VSC-producing microorganisms are selected from the group consisting of Fusobacterium nucleatum, Neisseria canis, Bergyella zoohelcum, Prevotella intermedia, Porphyromonas canigingivalis, Porphyromonas gingivalis, Tannerella forsythia, and Treponema denticola.
A8. The composition of Embodiment A6 or A7, wherein the one or more VSCs are selected from the group consisting of hydrogen sulfide, methyl mercaptan, and dimethyl sulfide.
A9. The composition of any one of the preceding Embodiments, wherein the composition reduces the level of gum inflammation, gingivitis, plaque, tartar, and/or dental calculus accumulation in an oral cavity of a subject.
A10. The composition of any one of the preceding Embodiments, wherein the composition treats or prevents one or more symptom of halitosis in a subject.
A11. The composition of any one of the preceding Embodiments, wherein each of the fermentates are in powdered form.
A12. The composition of any one of the preceding Embodiments, wherein each of the fermentates are lyophilized or spray-dried.
A13. The composition of any one of the preceding Embodiments, wherein each fermentate is present in an amount of 1 to 500 mg per dose.
A13.1 The composition of any one of the preceding Embodiments, wherein the composition comprises a total amount of fermentate of 1 to 500 mg per dose.
A14. The composition of any one of the preceding Embodiments, further comprising a carrier.
A15. The composition of Embodiment A14, wherein the carrier is maltodextrin.
A16. The composition of Embodiment A14 or A15, wherein the carrier is a tapioca-based maltodextrin.
B1. A nutritional supplement, dental supplement, or food product comprising the composition of any one of Embodiments A1-A16.
B1.1. The nutritional supplement, dental supplement, or food product of Embodiment B1, comprising the composition of any one of Embodiments A1-A16 at an incorporation rate of 0.01% to 10% [w/w].
B1.2. A nutritional supplement, dental supplement, or food product of Embodiment B1 or B1.1, comprising the composition of any one of the preceding Embodiments at an incorporation rate of 0.1% to 2% [w/w].
B2. The nutritional supplement, dental supplement, or food product of any one of Embodiments B1-B1.2, wherein the nutritional supplement is a canine nutritional supplement.
B3. The nutritional supplement, dental supplement, or food product of any one of Embodiments B1-B2, wherein the nutritional supplement comprises a meat or animal-derived material.
B4. The nutritional supplement, dental supplement, or food product of Embodiment B3, wherein the meat or animal-derived material is beef, chicken, eggs, turkey, lamb, fish, blood marrow, and/or bone marrow.
B5. The nutritional supplement, dental supplement, or food product of any one of B5. Embodiments B1-B4, further comprising a grain.
B6. The nutritional supplement, dental supplement, or food product of Embodiment B5, wherein the grain is wheat, corn, rice, oats, and/or barley.
B7. The nutritional supplement, dental supplement, or food product of any one of Embodiments B1-B6, further comprising a fiber.
B8. The nutritional supplement, dental supplement, or food product of Embodiment B7, wherein the fiber is sugar beet pulp, chicory pulp, chicory, coconut endosperm fiber, wheat fiber, fructooligosaccharides, galactooligosaccharides, and/or inulin.
B9. The nutritional supplement, dental supplement, or food product of any one of Embodiments B1-B8, further comprising algae.
B10. The nutritional supplement, dental supplement, or food product of Embodiment B9, wherein the algae is Ascophyllum nodosum, Spirulina, and/or Fucus vesiculosus.
B11. The nutritional supplement, dental supplement, or food product of any one of Embodiments B1-B10, further comprising a gelatinized starch matrix.
B12. The nutritional supplement, dental supplement, or food product of any one of Embodiments B1-B11, wherein the nutritional supplement, dental supplement, or food product reduces inflammation in a subject.
B13. The nutritional supplement, dental supplement, or food product of any one of Embodiments B1-B12, wherein the nutritional supplement, dental supplement, or food product treats or prevents a symptom associated with halitosis in a subject.
B14. The nutritional supplement, dental supplement, or food product of any one of Embodiments B1-B13, wherein the dental supplement is an extruded or injection-molded dental stick.
B15. The nutritional supplement, dental supplement, or food product of any one of Embodiments B1-B13, wherein the dental supplement is an extruded or injection-molded dental chew.
B16. The nutritional supplement, dental supplement, or food product of any one of Embodiments B1-B13, wherein the nutritional supplement or dental supplement is a chew having a soft interior.
B17. The nutritional supplement, dental supplement, or food product of any one of Embodiments B1-B13, wherein the nutritional supplement is a meal topper.
B18. The nutritional supplement, dental supplement, or food product of any one of Embodiments B1-B13, wherein the nutritional supplement is a water additive.
B19. The nutritional supplement, dental supplement, or food product of any one of Embodiments B1-B13, wherein the food product is an extruded kibble.
B20. The nutritional supplement, dental supplement, or food product of any one of Embodiments B1-B13, wherein the food product is a fresh food.
B21. The nutritional supplement, dental supplement, or food product of any one of Embodiments B1-B13, wherein the nutritional supplement is a liquid spray.
B22. The nutritional supplement, dental supplement, or food product of any one of Embodiments B1-B13, wherein the food product is peanut butter spread.
B23. The nutritional supplement, dental supplement, or food product of any one of Embodiments B1-B13, wherein the nutritional supplement, dental supplement, or food product is soft jerky chew.
C1. A method comprising administering the composition of any one of Embodiments A1-A16 or the nutritional supplement, dental supplement, or food product of any one of Embodiments B1-B23 to a subject.
C2. The method of Embodiment C1, wherein the administration is oral administration.
C3. The method of Embodiment C1 or C2, wherein the subject has or is at risk of having halitosis.
C4. The method of any one of Embodiments C1-C3, wherein an oral microenvironment of the subject comprises one or more bacterial strains selected from Porphyromonas gingivalis, Prevotella intermedia, Porphyromonas canigingivalis, Tannerella forsythia, Treponema denticola, Fusobacterium nucleatum, Neisseria canis, and Bergeyella zoohelcum.
C5. The method of any one of Embodiments C1-C4, wherein administration of the composition, nutritional supplement, dental supplement, or food product:
   (i) reduces the abundance of one or more VSCs in an oral microenvironment of the subject;
   (ii) reduces inflammation in the oral microenvironment of the subject;
   (iii) reduces the abundance of gingivitis, plaque, tartar, and/or dental calculus in the subject;
   (iv) reduces the abundance of one or more microorganisms associated with the production of VSCs;
   (v) reduces one or more symptom associated with halitosis; and/or
   (vi) improves oral health of the subject.
C6. The method of any one of Embodiments C1-C5, wherein the subject is a carnivore.
C7. The method of any one of Embodiments C1-C6, wherein the subject is a mammal.
C8. The method of any one of Embodiments C1-C7, wherein the subject is a domesticated animal.
C9. The method of any one of Embodiments C1-C8, wherein the subject is a bovine, swine, llama, alpaca, sheep, or goat.
C10. The method of any one of Embodiments C1-C8, wherein the subject is a dog, cat, rabbit, guinea pig, hamster, or ferret.
C11. The method of Embodiment C10, wherein the subject is a dog.

### EQUIVALENTS AND SCOPE

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

All references, patents and patent applications disclosed herein are incorporated by reference with respect to the subject matter for which each is cited, which in some cases may encompass the entirety of the document.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in some embodiments, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in some embodiments, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc. Each possibility represents a separate embodiment of the present invention.

It should be understood that, unless clearly indicated to the contrary, the disclosure of numerical values and ranges of numerical values in the specification includes both i) the exact value(s) or range specified, and ii) values that are “about” the value(s) or ranges specified (e.g., values or ranges falling within a reasonable range (e.g., about 10% similar)) as would be understood by a person of ordinary skill in the art.

It should also be understood that, unless clearly indicated to the contrary, in any methods disclosed herein that include more than one step or act, the order of the steps or acts of the method is not necessarily limited to the order in which the steps or acts of the method are disclosed.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

### EXAMPLES

### Example 1: Identification of Fermentates Reducing Volatile Sulfur Compound (VSC) Abundance and Disrupting Biofilms

Bacterial strains associated with bad breath in dogs, due to production of malodorous volatile sulfur compounds (VSCs), were identified. Fusobacterium nucleatum was used as an exemplary bacterial strain the model used in experiments described in this example due to its role in early stages of halitosis. F. nucleatum was grown for 2 days, treated with one of a panel of experimental compositions outlined in the table below, then allowed to grow for another 24 hours. VSC levels were quantified at the end of this 24-hour period.

| Composition | Contents |
|---|---|
| Negative Control | Media only |
| Positive Control | Acetic acid solution |
| Fermentate A | Fermentate of bacterial strain with 16S rDNA |
| | sequence of SEQ ID NO: 6 |
| Fermentate B | Fermentate of bacterial strain with 16S rDNA |
| | sequence of SEQ ID NO: 1 |
| Fermentate C | Fermentate of bacterial strain with 16S rDNA |
| | sequence of SEQ ID NO: 5 |
| Fermentate | Fermentate of 1:1:1 mixture of bacterial strains |
| A + B + C | having 16S rDNA sequences of SEQ ID NOs. 1, 5, |
| | and 6. |

VSC levels were assayed using a colorimetric assay based on the interaction between free sulfhydryl groups in solution and DTNB (5,5′-Dithiobis(2-nitrobenzoic acid)), which cause the solution to change color. Changes in absorption were measured and normalized to the positive and negative control groups.

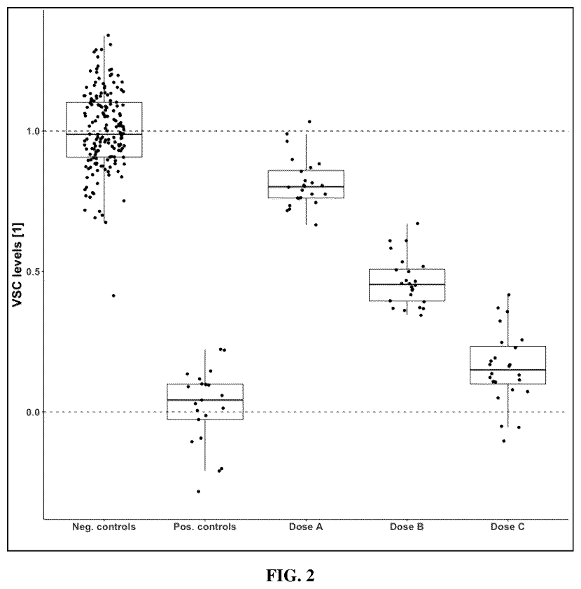

At the relevant dosage, a statistically significant reduction in VSC of 50%, as well as synergy between the strains, was observed with the fermentate of strains A, B, and C (FIG. 1). Reduction is dose-dependent, with VSCs being further increased at higher doses of fermentate (FIG. 2).

Fermentate compositions were further evaluated for their ability to disrupt biofilms of canine oral microflora. Canine oral microbiome samples were collected from dogs. Individual strains were isolated and identified through sequencing. Two canine strains were selected based on their ability to form biofilms and also produce VSCs: Neisseria canis and Bergeyella zoohelcum.

Canine oral microflora strains were grown for 24 hours in liquid media, treated with a fermentate composition (or positive control (protease K solution) or negative control (media only)), and rinsed to remove any debris. To quantify biofilm disruption, samples were labeled with DAPI, then imaged with a high-content optical microscope. Resulting images were processed to quantify the area covered in biofilm.

At the relevant dosage and treatment time (5 minutes), statistically significant biofilm disruption was observed following treatment with fermentate of a bacterial strain having a 16S rDNA sequence of SEQ ID NO: 1 (FIG. 3). While negative control (media only) resulted in a biofilm area of 54%, treatment with fermentates showed a near-complete biofilm disruption, resulting in a biofilm area of only 13%. These results indicate that fermentates have the ability of disrupt biofilm of an oral canine microbe.

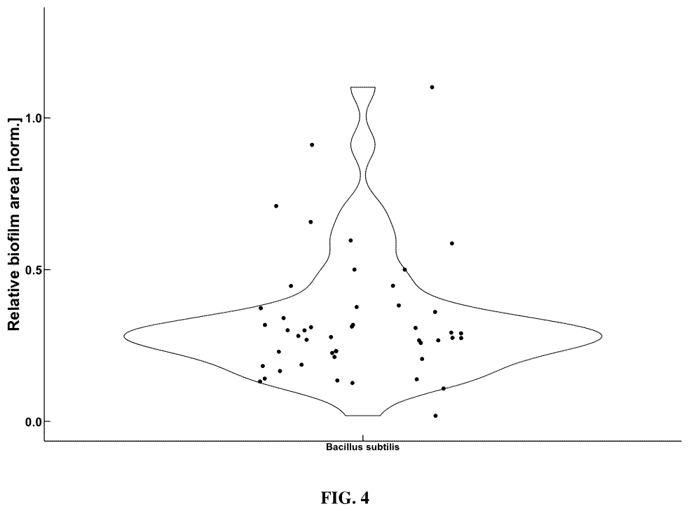

In another experiment, a biofilm-forming microbe isolated from canine oral microbiota and observed to produce VSCs was grown in microwell plates for 24 hours. Each well was treated for five minutes with a different test fermentate, and wells were then washed. Wells were labeled with DNA-staining dye DAPI and imaged using fluorescence microscopy to measure biofilm areas in each well, which were normalized to wells treated with a negative control (media only). Test materials included individual fermentates of 53 different Bacillus subtilis strains. 88% of the Bacillus subtilis fermentates achieved a statistically significant reduction in biofilm area, with 75% of fermentates reducing biofilm area by more than 50% (FIG. 4). These results support the general ability of Bacillus subtilis fermentates to disrupt canine oral microbiota biofilms.

1. A composition that reduces abundance of one or more volatile sulfur compounds (VSCs) and disrupts a biofilm of a canine oral microbe belonging to the species Neisseria canis in an oral microenvironment of a canine subject, for treating halitosis in the canine subject, the composition comprising a bacterial fermentate mixture, the bacterial fermentate mixture comprising:
(i) a first fermentate that disrupts a biofilm of a canine oral microbe belonging to the species Neisseria canis, the first fermentate being a fermentate of a first bacterial strain that
(a) comprises a 16S rDNA sequence with at least 99% sequence identity to the nucleic acid sequence of SEQ ID NO: 1 and belongs to the species Bacillus subtilis;
(b) comprises a 16S rDNA sequence with at least 99% sequence identity to the nucleic acid sequence of SEQ ID NO: 2 and belongs to the species Bacillus amyloliquefaciens; or
(c) comprises a 16S rDNA sequence with at least 99% sequence identity to the nucleic acid sequence of SEQ ID NO: 4 and belongs to the species Bacillus pumilus; and
(ii) a second fermentate that reduces abundance of one or more VSCs, the second fermentate being a fermentate of a second bacterial strain comprising a 16S rDNA sequence with at least 97% 99% sequence identity to the nucleic acid sequence of SEQ ID NO: 5 and belonging to the species Pediococcus pentosaceus,
wherein each of the fermentates is in powder form, and
wherein the composition is a nutritional supplement, dental supplement, or food product.

2. The composition of claim 1, wherein the nutritional supplement, dental supplement, or food product comprises maltodextrin.

3. The composition of claim 1, wherein the nutritional supplement, dental supplement, or food product comprises a starch and/or a fiber.

4. The composition of claim 3, wherein the nutritional supplement, dental supplement, or food product comprises tapioca and/or a fiber selected from the group consisting of sugar beet pulp, chicory pulp, chicory, coconut endosperm fiber, wheat fiber, fructooligosaccharides, galactooligosaccharides, and inulin.

5. The composition of claim 1, wherein the nutritional supplement, dental supplement, or food product is in the form of gelatinized starch matrix, extruded or injection-molded dental stick, extruded or injection-molded dental chew, chew having a soft interior, powder meal topper, water additive, dry kibble or food, wet food, frozen food, liquid spray, peanut butter spread, or soft jerky chew.

6. The composition of claim 1, wherein each of the fermentates is lyophilized or spray-dried.

7. The composition of claim 1, wherein the bacterial fermentate mixture consists essentially of the first fermentate of (i) and the second fermentate of (ii).

8.-10. (canceled)

11. The composition of claim 1, wherein each of the fermentates is present in the nutritional supplement, dental supplement, or food product at an amount of 1 to 500 mg.

12. The composition of claim 1, wherein the bacterial fermentate mixture is present in the nutritional supplement, dental supplement, or food product at an incorporation rate of 0.01% to 10% w/w.

13.-18. (canceled)

19. The composition of claim 1, wherein the composition is a nutritional supplement, wherein the nutritional supplement comprises a grain selected from the group consisting of wheat, corn, rice, oats, and barley.

20. The composition of claim 1, wherein the composition is a nutritional supplement, wherein the nutritional supplement comprises a meat or animal-derived protein source.

21. The composition of claim 1, wherein the first bacterial strain comprises a 16S rDNA sequence with at least 99% sequence identity to the nucleic acid sequence of SEQ ID NO: 1 and belongs to the species Bacillus subtilis.

22. The composition of claim 21, wherein the bacterial fermentate mixture consists essentially of the first fermentate of (i) and the second fermentate of (ii).
